(19) United States
(12) Patent Application Publication
(10) Pub. No.: US 2023/0035039 A1
(43) Pub. Date: Feb. 2, 2023

(54) ANALYSIS DEVICE

(71) Applicant: Keyence Corporation, Osaka (JP)

(72) Inventors: Kenichiro HIROSE, Osaka (JP); Ryosuke KONDO, Osaka (JP); Hayato OHBA, Osaka (JP)

(73) Assignee: Keyence Corporation, Osaka (JP)

(21) Appl. No.: 17/853,956

(22) Filed: Jun. 30, 2022

(30) Foreign Application Priority Data
Jul. 30, 2021 (JP) 2021-126156

(51) Int. Cl. G01N 21/31; G01N 23/2251; G01N 27/64; G06V 10/74; G06F 3/14

(52) U.S. Cl. CPC G01N 21/31; G01N 23/2251; G01N 27/64; G06V 10/761; G06F 3/14; G01N 2223/079; G01N 2223/507; G06F 3/0482

(57) ABSTRACT

An analysis and observation device includes: a component analysis section that performs component analysis of an analyte; an output section that outputs one component analysis result to an analysis history holding section; the analysis history holding section that holds a plurality of component analysis results as an analysis history; and an identifying section that identifies a component analysis result similar to the component analysis result obtained by the component analysis section from among the plurality of component analysis results held in the analysis history holding section. The analysis history holding section holds the analysis history to which the component analysis result has been newly added according to the output of the component analysis result by the output section, and the identifying section identifies a component analysis result similar to the one component analysis result from among results of the component analysis performed by the component analysis section.

### CROSS-REFERENCE TO RELATED APPLICATIONS

The present application claims foreign priority based on Japanese Patent Application No. 2021-126156, filed Jul. 30, 2021, the contents of which are incorporated herein by reference.

### BACKGROUND OF THE INVENTION

### 1. Field of the Invention

The technique disclosed herein relates to an analysis device and an analysis method for performing component analysis of a measurement object.

### 2. Description of Related Art

For example, JP 2020-113569 A discloses an analysis device (spectroscopic device) configured to perform component analysis of a sample. Specifically, the spectroscopic device disclosed in JP 2020-113569 A includes a condenser lens, configured to collect a primary electromagnetic wave (ultraviolet laser light), and a collection head configured to collect a secondary electromagnetic wave (plasma) generated on a sample surface in response to the primary electromagnetic wave in order to perform the component analysis using laser induced breakdown spectroscopy (LIBS).

According to JP 2020-113569 A, a peak of a spectrum of the sample is measured from a signal of the secondary electromagnetic wave so that chemical analysis of the sample based on the measured peak can be executed.

Users who perform component analysis sometimes make a comparison with component analysis results of a sample in the past in order verify the validity of a component analysis result. However, to identify which component analysis result in the past is similar to the component analysis result of the sample is difficult and time-consuming work for a user who is not familiar with the analysis. Further, even if it is possible to identify which component analysis result in the past is similar, it is difficult to exclude the user's subjective determination. Therefore, it is difficult to objectively identify a similar component analysis result, that is, to identify the similar component analysis result with a high reproducibility.

### SUMMARY OF THE INVENTION

The technique disclosed herein has been made in view of the above points, and an object thereof is to objectively identify which component analysis result in the past is similar to a component analysis result of a sample, and to improve the usability of an analysis device.

In order to achieve the above object, one embodiment of the present invention can be premised on an analysis device that performs component analysis of an analyte.

The analysis device includes: a placement stage on which an analyte is placed; an emitter which emits an electromagnetic wave or an electron beam to the analyte placed on the placement stage; a spectrum acquirer which acquires a spectrum obtained from the analyte irradiated with the electromagnetic wave or electron beam emitted from the emitter; a component analysis section which performs component analysis of the analyte based on the spectrum acquired by the spectrum acquirer; an analysis history holding section which holds a plurality of component analysis results obtained by the component analysis section as an analysis history; an identifying section which identifies a component analysis result similar to one component analysis result obtained by the component analysis section among the plurality of component analysis results held in the analysis history holding section; and a display controller which causes a display to display the component analysis result identified by the identifying section.

According to this configuration, the analysis history holding section updates the analysis history by accumulating a newly received component analysis result in the existing analysis history in addition to the plurality of component analysis results already held as the analysis history. That is, the analysis history holding section can accumulate a plurality of results of the component analysis performed in the past by the component analysis section as the analysis history. Then, the identifying section identifies the component analysis result similar to the one component analysis result from among the plurality of component analysis results held in the analysis history holding section. Therefore, it is possible to identify which result of component analysis performed in the past by the component analysis section is similar to the one component analysis result. Then, the display controller causes the display to display the identified component analysis result, so that a user can grasp which component analysis result is similar.

According to another embodiment of the present invention, the analysis device includes: a first imaging section which receives reflection light reflected by the analyte placed on the placement stage; an imaging processor which generates images of the analyte based on the reflection light received by the first imaging section; and an input receiver which receives a search start input for performing the identification of the component analysis result by the identifying section.

Then, the analysis history holding section holds, as the analysis history, a plurality of analysis records in which the component analysis results obtained by the component analysis section are associated with the images generated by the imaging processor when the component analysis results are acquired, respectively. Further, the identifying section identifies an analysis record having a component analysis result similar to the one component analysis result obtained by the component analysis section as a similar analysis record from among the plurality of analysis records held in the analysis history holding section in response to reception of the search start input by the input receiver. Then, the display controller causes the display to display the component analysis result included in the similar analysis record identified by the identifying section and the image associated with the component analysis result.

According to this configuration, the identifying section can identify the similar analysis record based on not only the component analysis result but also a difference in shape and color of a measurement object.

According to still another embodiment of the present invention, the identifying section can calculate a similarity degree based on the one component analysis result and the component analysis result included in the analysis record, for each of the plurality of analysis records held in the analysis history holding section. Then, the identifying section identifies a plurality of the similar analysis records based on the calculated similarity degree. Furthermore, the display controller causes the display to display a list of the images respectively included in the plurality of similar analysis records

According to this configuration, the identifying section can display the plurality of similar analysis records based on the similarity degree, for example, by displaying the plurality of similar analysis records in descending order of the similarity degree. There is a case where the analysis record identified by the identifying section as being most similar to the one component analysis result is not always what the user wants. Even in such a case, since the plurality of similar analysis records each having a high similarity degree are displayed in the list format, the user can easily identify a desired similar analysis record.

According to still another embodiment of the present invention, the identifying section can calculate an analysis similarity degree, which is the similarity degree between the one component analysis result and the component analysis result included in the analysis record, and an image similarity degree, which is a similarity degree between the image associated with the one component analysis result and the image included in the analysis record, for the plurality of analysis records held in the analysis history holding section. Then, the identifying section identifies a plurality of the similar analysis records based on the analysis similarity degree and the image similarity degree.

According to this configuration, the identifying section can identify the similar analysis record based on both the component analysis result and the image, and it is possible to more accurately identify the similar analysis record.

According to still another embodiment of the present invention, the analysis device includes an analysis setting section that receives an analysis setting by the component analysis section. Then, the analysis setting section can receive selection or an input of an essential item estimated to be included in the analyte. Furthermore, when the analysis setting section receives the selection or input of the essential item, the component analysis section re-extracts a characteristic as the characteristic of the analyte by setting the essential item as an extraction target.

According to this configuration, it is possible to set to extract the essential item, which is the characteristic that is recognized as being included in the analyte in advance by the user, so that it is possible to identify what is closer to the component analysis result intended by the user.

According to still another embodiment of the present invention, the analysis setting section can receive selection or an input of an excluded item estimated not to be included in the analyte. Then, when the analysis setting section receives the selection or input of the excluded item, the component analysis section re-extracts a characteristic as the characteristic of the analyte by setting the excluded item to be excluded from extraction targets.

According to this configuration, it is possible to set to the excluded item, which is the characteristic that is recognized as not being included in the analyte in advance by the user, to be excluded from the extraction targets so that it is possible to identify what is closer to the component analysis result intended by the user.

According to still another embodiment of the present invention, the analysis history holding section holds the spectrum in association with the component analysis result as the analysis record. Then, the display controller can cause the display to display a difference spectrum representing a difference between a spectrum associated with one component analysis result and a spectrum included in the similar analysis record. Furthermore, the display controller displays a peak position of the spectrum associated with the one component analysis result to be distinguishable on the difference spectrum.

According to this configuration, the user can intuitively determine whether or not the spectra are similar to each other.

It is possible to objectively identify which component analysis result of the sample is similar to which component analysis result in the past, and it is possible to improve the usability of the analysis device.

### BRIEF DESCRIPTION OF THE DRAWINGS

FIG. 1 is a schematic diagram illustrating an overall configuration of an analysis and observation device;

FIG. 2 is a side view schematically illustrating a configuration of the optical system assembly;

FIG. 3 is a schematic view illustrating a configuration of an analysis optical system;

FIG. 4 is a view for describing the horizontal movement of the head;

FIG. 5 is a block diagram illustrating a configuration of a controller;

FIG. 6 is a view for describing a concept of a substance library;

FIG. 7 is a view for describing an analysis setting;

FIG. 8 is a flowchart illustrating a sample analysis procedure by the controller;

FIG. 9 is a view illustrating an illumination setting screen;

FIGS. 10A, 10B, and 10C are views illustrating image display screens;

FIG. 11 is a view for describing an acquisition condition;

FIG. 12 is a flowchart illustrating a sample analysis procedure by the controller;

FIG. 13 is a view for describing an output image selection screen;

FIG. 14 is a diagram for describing an analysis history holding section;

FIGS. 15A and 15B are views for describing a method for calculating a similarity degree;

FIG. 16 is a view for describing the method for calculating the similarity degree;

FIG. 17 is a view for describing the method for calculating the similarity degree;

FIGS. 18A and 18B are views for describing a search setting screen;

FIG. 19 is a flowchart illustrating a similarity search procedure by the controller;

FIG. 20A is a view illustrating a display screen of a display;

FIG. 20B is a view illustrating the display screen of the display;

FIG. 20C is a view illustrating the display screen of the display; and

FIG. 21 is a view for describing a characteristic of an analyte.

### DETAILED DESCRIPTION OF PREFERRED EMBODIMENTS

Hereinafter, an embodiment of the present disclosure will be described with reference to the drawings. Note that the following description is given as an example.

<Overall Configuration of Analysis and Observation Device A>

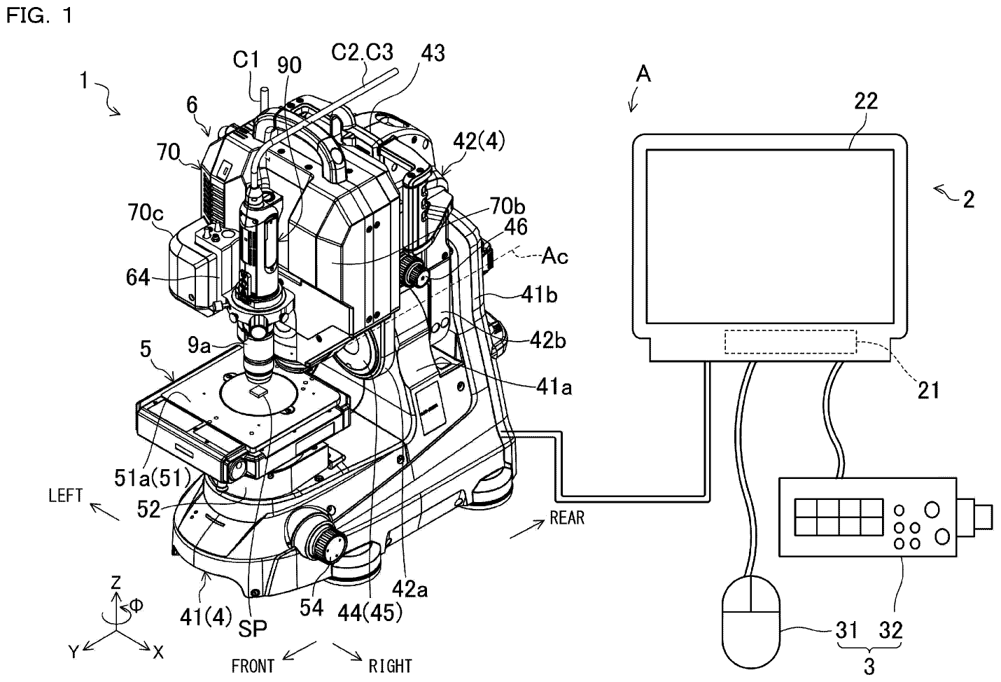

FIG. 1 is a schematic diagram illustrating an overall configuration of an analysis and observation device A as an analysis device according to an embodiment of the present disclosure. The analysis and observation device A illustrated in FIG. 1 can perform magnifying observation of a sample SP, which serves as both of an observation target and an analyte, and can also perform component analysis of the sample SP.

Specifically, for example, the analysis and observation device A according to the present embodiment can search for a site where component analysis is to be performed in the sample SP and perform inspection, measurement, and the like of an appearance of the site by magnifying and capturing an image of the sample SP including a specimen such as a micro object, an electronic component, a workpiece, and the like. When focusing on an observation function, the analysis and observation device A can be referred to as a magnifying observation device, simply as a microscope, or as a digital microscope.

The analysis and observation device A can also perform a method referred to as a laser induced breakdown spectroscopy (LIBS), laser induced plasma spectroscopy (LIPS), or the like in the component analysis of the sample SP. When focusing on an analysis function, the analysis and observation device A can be referred to as a component analysis device, simply as an analysis device, or as a spectroscopic device.

As illustrated in FIG. 1, the analysis and observation device A according to the present embodiment includes an optical system assembly (optical system main body) 1, a controller main body 2, and an operation section 3 as main constituent elements.

Among them, the optical system assembly 1 can perform capturing and analysis of the sample SP and output an electrical signal corresponding to a capturing result and an analysis result to the outside.

The controller main body 2 includes a controller 21 configured to control various components constituting the optical system assembly 1 such as a first camera 81. The controller main body 2 can cause the optical system assembly 1 to observe and analyze the sample SP using the controller 21. The controller main body 2 also includes a display 22 capable of displaying various types of information. The display 22 can display an image captured in the optical system assembly 1, data indicating the analysis result of the sample SP, and the like.

The operation section 3 includes a mouse 31, a console 32, and the like that receive an operation input performed by a user. The console 32 can instruct acquisition of image data, brightness adjustment, and focusing of the first camera 81 or the like to the controller main body 2 by operating a button, an adjustment knob, and the like.

<Details of Optical System Assembly 1>

As illustrated in FIG. 1, the optical system assembly 1 includes: a stage 4 which supports various instruments and on which the sample SP is placed; and a head 6 attached to the stage 4. Here, the head 6 is formed by mounting an observation housing 90 in which an observation optical system 9 is accommodated onto an analysis housing 70 in which an analysis optical system 7 is accommodated. Here, the analysis optical system 7 is an optical system configured to perform the component analysis of the sample SP. The observation optical system 9 is an optical system configured to perform the magnifying observation of the sample SP. The head 6 is configured as a device group having both of an analysis function and a magnifying observation function of the sample SP.

Note that the front-rear direction and the left-right direction of the optical system assembly 1 are defined as illustrated in FIG. 1 in the following description. That is, one side opposing the user is a front side of the optical system assembly 1, and an opposite side thereof is a rear side of the optical system assembly 1. When the user opposes the optical system assembly 1, a right side as viewed from the user is a right side of the optical system assembly 1, and a left side as viewed from the user is a left side of the optical system assembly 1. Note that the definitions of the front-rear direction and the left-right direction are intended to help understanding of the description, and do not limit an actual use state. Any direction may be used as the front.

The head 6 can move along a central axis Ac illustrated in FIG. 1 or swing about the central axis Ac although will be described in detail later. As illustrated in FIG. 1 and the like, the central axis Ac extends along the above-described front-rear direction.

(Stage 4)

The stage 4 includes a base 41 installed on a workbench or the like, a stand 42 connected to the base 41, and a placement stage 5 supported by the base 41 or the stand 42. The stage 4 is a member configured to define a relative positional relation between the placement stage 5 and the head 6, and is configured such that at least the observation optical system 9 and the analysis optical system 7 of the head 6 are attachable thereto.

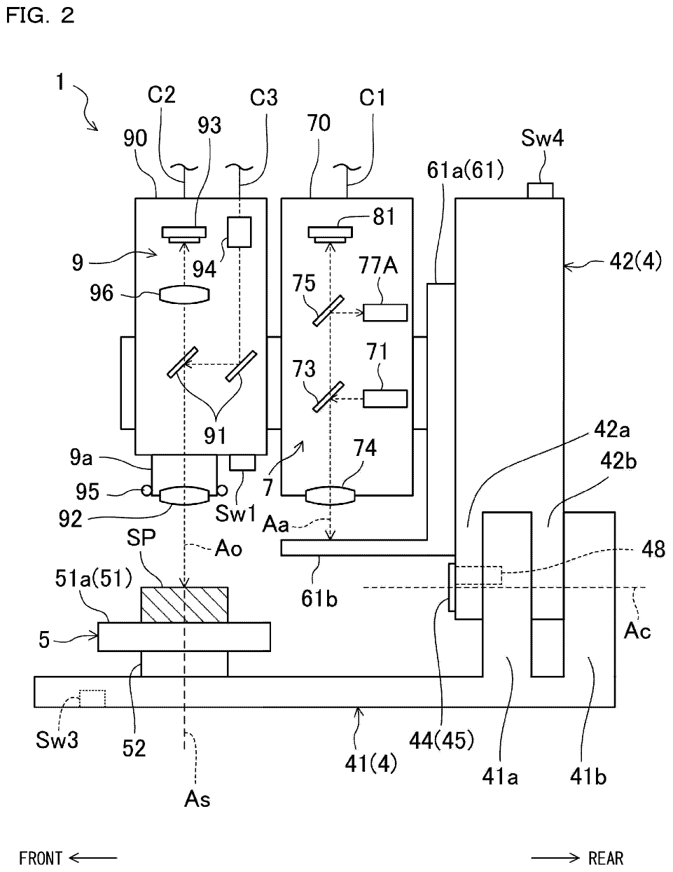

As illustrated in FIG. 2, the first supporter 41a and the second supporter 41b are provided on a rear portion of the base 41 in a state of being arranged side by side in order from the front side. Both the first and second supporters 41a and 41b are provided so as to protrude upward from the base 41. Circular bearing holes (not illustrated) arranged to be concentric with the central axis Ac are formed in the first and second supporters 41a and 41b.

Further, a first attachment section 42a and a second attachment section 42b are provided in a lower portion of the stand 42 in a state of being arranged side by side in order from the front side as illustrated in FIG. 2. The first and second attachment sections 42a and 42b have configurations corresponding to the first and second supporters 41a and 41b, respectively. Specifically, the first and second supporters 41a and 41b and the first and second attachment sections 42a and 42b are laid out such that the first supporter 41a is sandwiched between the first attachment section 42a and the second attachment section 42b and the second attachment section 42b is sandwiched between the first supporter 41a and the second supporter 41b.

Further, circular bearing holes (not illustrated) concentric with and having the same diameter as the bearing holes formed in the first and second attachment sections 42a and 42b are formed in the first and second supporters 41a and 41b. A shaft member 44 is inserted into these bearing holes via a bearing (not illustrated) such as a cross-roller bearing. The shaft member 44 is arranged such that the axis thereof is concentric with the central axis Ac. The base 41 and the stand 42 are coupled so as to be relatively swingable by inserting the shaft member 44. The shaft member 44 forms a tilting mechanism 45 in the present embodiment together with the first and second supporters 41a and 41b and the first and second attachment sections 42a and 42b.

Further, the overhead camera 48 is incorporated in the shaft member 44 forming the tilting mechanism 45 as illustrated in FIG. 2. This overhead camera 48 receives visible light reflected by the sample SP through a through-hole 44a provided on a front surface of the shaft member 44. The overhead camera 48 captures an image of the sample SP by detecting a light reception amount of the received reflection light.

An imaging visual field of the overhead camera 48 is wider than imaging visual fields of the first camera 81 and a second camera 93 which will be described later. In other words, an enlargement magnification of the overhead camera 48 is smaller than enlargement magnifications of the first camera 81 and the second camera 93. Therefore, the overhead camera 48 can capture the sample SP over a wider range than the first camera 81 and the second camera 93.

Specifically, the overhead camera 48 according to the present embodiment photoelectrically converts light incident through the through-hole 44a by a plurality of pixels arranged on a light receiving surface thereof, and converts the light into an electrical signal corresponding to an optical image of a subject (the sample SP).

The overhead camera 48 may have a plurality of light receiving elements arranged along the light receiving surface. In this case, each of the light receiving elements corresponds to a pixel so that an electrical signal based on the light reception amount in each of the light receiving elements can be generated. Specifically, the overhead camera 48 according to the present embodiment is configured using an image sensor including a complementary metal oxide semiconductor (CMOS), but is not limited to this configuration. As the overhead camera 48, for example, an image sensor including a charged-coupled device (CCD) can also be used.

Then, the overhead camera 48 inputs an electrical signal generated by detecting the light reception amount by each light receiving element to the controller 21 of the controller main body 2. The controller 21 generates image data corresponding to the optical image of the subject based on the input electrical signal. The controller 21 can cause the display 22 or the like to display the image data thus generated as the image obtained by capturing the image of the subject.

Note that the above-described configuration of the overhead camera 48 is merely an example. It suffices that the overhead camera 48 has a wider imaging visual field than the first camera 81 and the second camera 93, and the layout of the overhead camera 48, a direction of its imaging optical axis, and the like can be freely changed. For example, the overhead camera 48 may be configured using a USB camera connected to the optical system assembly 1 or the controller main body 2 in a wired or wireless manner.

Returning to the description of the base 41 and the stand 42, a first tilt sensor Sw3 is incorporated in the base 41. The first tilt sensor Sw3 can detect a tilt of the reference axis As perpendicular to the placement surface 51a with respect to the direction of gravity. On the other hand, a second tilt sensor Sw4 is attached to the stand 42. The second tilt sensor Sw4 can detect a tilt of the analysis optical system 7 with respect to the direction of gravity (more specifically, a tilt of the analysis optical axis Aa with respect to the direction of gravity). Detection signals of the first tilt sensor Sw3 and the second tilt sensor Sw4 are both input to the controller 21.

(Head 6)

The head 6 includes the head attachment member 61, an analysis unit in which the analysis optical system 7 is accommodated in the analysis housing 70, an observation unit in which the observation optical system 9 is accommodated in the observation housing 90, a housing coupler 64, and a slide mechanism (horizontal drive mechanism) 65. The head attachment member 61 is a member configured to connect the analysis housing 70 to the stand 42. The analysis unit is a device configured to perform the component analysis of the sample SP by the analysis optical system 7. The observation unit 63 is a device configured to perform the observation of the sample SP by the observation optical system 9. The housing coupler 64 is a member configured to connect the observation housing 90 to the analysis housing 70. The slide mechanism 65 is a mechanism configured to slide the analysis housing 70 with respect to the stand 42.

Hereinafter, the configurations of the analysis unit, the observation unit, and the slide mechanism 65 will be sequentially described.

—Analysis Unit—

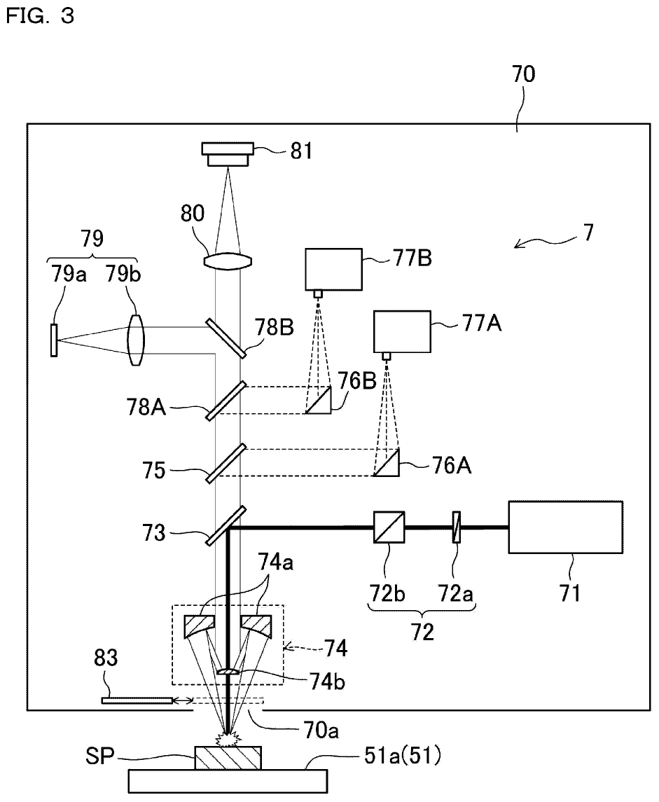

FIG. 3 is a schematic view illustrating the configuration of the analysis optical system 7.

The analysis unit includes the analysis optical system 7 and the analysis housing 70 in which the analysis optical system 7 is accommodated. The analysis optical system 7 is a set of components configured to analyze the sample SP as an analyte, and the respective components are accommodated in the analysis housing 70. The analysis housing 70 accommodates the first camera 81 as an imaging section and first and second detectors 77A and 77B as detectors. Further, elements configured to analyze the sample SP also include the controller 21 of the controller main body 2.

The analysis optical system 7 can perform analysis using, for example, an LIBS method. A communication cable C1, configured to transmit and receive an electrical signal to and from the controller main body 2, is connected to the analysis optical system 7. The communication cable C1 is not essential, and the analysis optical system 7 and the controller main body 2 may be connected by wireless communication.

Note that the term “optical system” used herein is used in a broad sense. That is, the analysis optical system 7 is defined as a system including a light source, an image capturing element, and the like in addition to an optical element such as a lens. The same applies to the observation optical system 9.

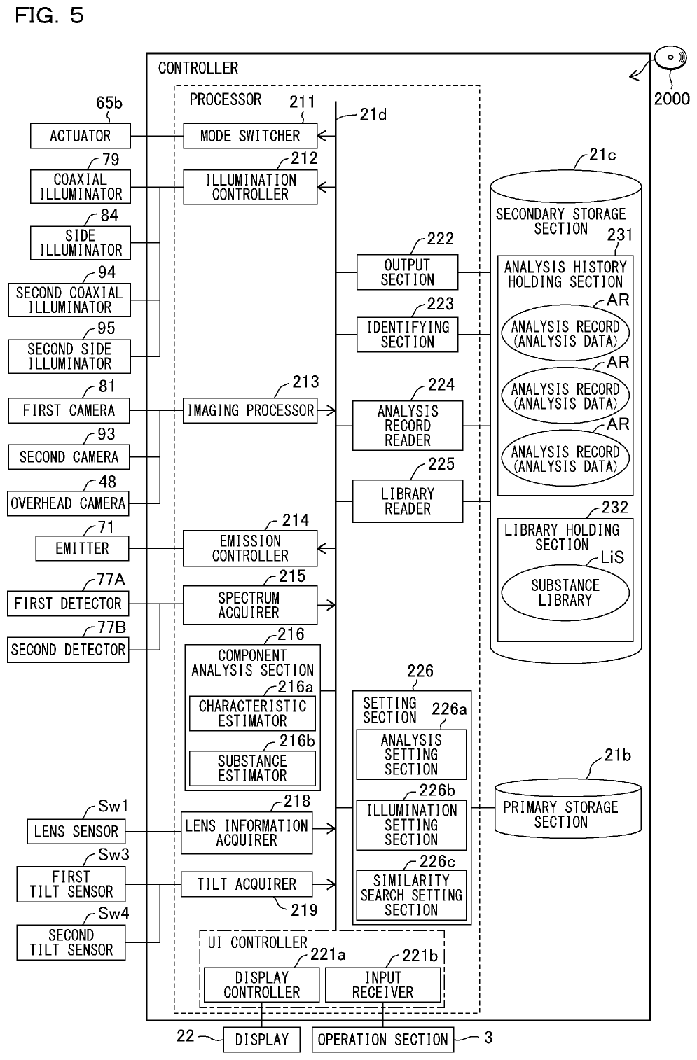

As illustrated in FIG. 3, the analysis optical system 7 according to the present embodiment includes the emitter 71, an output adjuster 72, the deflection element 73, the reflective object lens 74 as the collection head, a dispersing element 75, a first parabolic mirror 76A, the first detector 77A, a first beam splitter 78A, a second parabolic mirror 76B, the second detector 77B, a second beam splitter 78B, a coaxial illuminator 79, an imaging lens 80, a first camera 81, and the side illuminator 84. Some of the constituent elements of the analysis optical system 7 are also illustrated in FIG. 2. Further, the side illuminator 84 is illustrated only in FIG. 5.

The emitter 71 emits a primary electromagnetic wave to the sample SP. In particular, the emitter 71 according to the present embodiment includes a laser light source that emits laser light as the primary electromagnetic wave to the sample SP. Note that the emitter 71 according to the present embodiment can output the laser light formed of ultraviolet rays as the primary electromagnetic wave.

The output adjuster 72 is arranged on an optical path connecting the emitter 71 and the deflection element 73, and can adjust an output of the laser light (primary electromagnetic wave).

The laser light (primary electromagnetic wave) whose output has been adjusted by the output adjuster 72 is reflected by a mirror (not illustrated) and is incident on the deflection element 73.

Specifically, the deflection element 73 is laid out so as to reflect the laser light, which has been output from the emitter 71 and passed through the output adjuster 72, to be guided to the sample SP via the reflective object lens 74, and allow passage of light (which is light emitted due to plasma occurring on the surface of the sample SP, and is hereinafter referred to as “plasma light”) generated in the sample SP in response to the laser light and guide the secondary electromagnetic wave to the first detector 77A and the second detector 77B. The deflection element 73 is also laid out to allow passage of visible light collected for capturing and guide most of the visible light to the first camera 81.

Ultraviolet laser light reflected by the deflection element 73 propagates along the analysis optical axis Aa as parallel light and reaches the reflective object lens 74.

The reflective object lens 74 as the collection head is configured to collect the secondary electromagnetic wave generated in the sample SP as the sample SP is irradiated with the primary electromagnetic wave emitted from the emitter 71. In particular, the reflective object lens 74 according to the present embodiment is configured to collect the laser light as the primary electromagnetic wave and irradiate the sample SP with the laser light, and collect the plasma light (secondary electromagnetic wave) generated in the sample SP in response to the laser light (primary electromagnetic wave) applied to the sample SP. In this case, the secondary electromagnetic wave corresponds to the plasma light emitted due to the plasma occurring on the surface of the sample SP.

The reflective object lens 74 has the analysis optical axis Aa extending along the substantially vertical direction. The analysis optical axis Aa is provided to be parallel to the observation optical axis Ao of an objective lens 92 of the observation optical system 9.

Specifically, the reflective object lens 74 according to the present embodiment is a Schwarzschild objective lens including two mirrors. As illustrated in FIG. 3, the reflective object lens 74 includes primary mirror 74a having a partial annular shape and a relatively large diameter, and a secondary mirror 74b having a disk shape and a relatively small diameter.

The primary mirror 74a allows the laser light (primary electromagnetic wave) to pass through an opening provided at the center thereof, and reflects the plasma light (secondary electromagnetic wave) generated in the sample SP by a mirror surface provided in the periphery thereof. The latter plasma light is reflected again by a mirror surface of the secondary mirror 74b, and passes through the opening of the primary mirror 74a in a state of being coaxial with the laser light.

The secondary mirror 74b is configured to transmit the laser light having passed through the opening of the primary mirror 74a and collect and reflect the plasma light reflected by the primary mirror 74a. The former laser light is applied to the sample SP, but the latter plasma light passes through the opening of the primary mirror 74a and reaches the deflection element 73 as described above.

The dispersing element 75 is arranged between the deflection element 73 and the first beam splitter 78A in the optical axis direction (direction along the analysis optical axis Aa) of the reflective object lens 74, and guides a part of the plasma light generated in the sample SP to the first detector 77A and the other part to the second detector 77B or the like. Most of the latter plasma light is guided to the second detector 77B, but the rest reaches the first camera 81.

The first parabolic mirror 76A is a so-called parabolic mirror, and is arranged between the dispersing element 75 and the first detector 77A. The first parabolic mirror 76A collects the secondary electromagnetic wave reflected by the dispersing element 75, and causes the collected secondary electromagnetic wave to be incident on the first detector 77A.

The first detector 77A receives the plasma light (secondary electromagnetic wave) generated in the sample SP and collected by the reflective object lens 74, and generates a spectrum which is an intensity distribution for each wavelength of the plasma light.

In particular, in a case where the emitter 71 is configured using the laser light source and the reflective object lens 74 is configured to collect the plasma light as the secondary electromagnetic wave generated in response to the irradiation of laser light as the primary electromagnetic wave, the first detector 77A reflects light at different angles for each wavelength to separate the light, and causes each beam of the separated light to be incident on an imaging element having a plurality of pixels. As a result, a wavelength of light received by each pixel can be made different, and a light reception intensity can be acquired for each wavelength. In this case, the spectrum corresponds to an intensity distribution for each wavelength of light.

Note that the spectrum may be configured using the light reception intensity acquired for each wave number. Since the wavelength and the wave number uniquely correspond to each other, the spectrum can be regarded as the intensity distribution for each wavelength even when the light reception intensity acquired for each wave number is used. The same applies to the second detector 77B which will be described later.

The first beam splitter 78A reflects a part of light, transmitted through the dispersing element 75 (secondary electromagnetic wave on the infrared side including the visible light band), to be guided to the second detector 77B, and transmits the other part (a part of the visible light band) to be guided to the second beam splitter 78B. A relatively large amount of plasma light is guided to the second detector 77B out of plasma light belonging to the visible light band, and a relatively small amount of plasma light is guided to the first camera 81 via the second beam splitter 78B.

The second parabolic mirror 76B is a so-called parabolic mirror and is arranged between the first beam splitter 78A and the second detector 77B, which is similar to the first parabolic mirror 76A. The second parabolic mirror 76B collects a secondary electromagnetic wave reflected by the first beam splitter 78A, and causes the collected secondary electromagnetic wave to be incident on the second detector 77B.

The second detector 77B receives the secondary electromagnetic wave generated in the sample SP as the sample SP is irradiated with the primary electromagnetic wave emitted from the emitter 71 and generates a spectrum which is an intensity distribution of the secondary electromagnetic wave for each wavelength, which is similar to the first detector 77A.

The ultraviolet spectrum generated by the first detector 77A and the infrared spectrum generated by the second detector 77B are input to the controller 21. The controller 21 performs component analysis of the sample SP using a basic principle, which will be described later, based on these spectra. The controller 21 can perform the component analysis using a wider frequency range by using the ultraviolet spectrum and the infrared intensity in combination.

The second beam splitter 78B reflects illumination light (visible light), which has been emitted from an LED light source 79a and passed through the optical element 79b, and irradiates the sample SP with the illumination light via the first beam splitter 78A, the dispersing element 75, the deflection element 73, and the reflective object lens 74. Reflection light (visible light) reflected by the sample SP returns to the analysis optical system 7 via the reflective object lens 74.

The coaxial illuminator 79 includes the LED light source 79a that emits the illumination light, and the optical element 79b through which the illumination light emitted from the LED light source 79a passes. The coaxial illuminator 79 functions as a so-called “coaxial epi-illuminator”. The illumination light emitted from the LED light source 79a propagates coaxially with the laser light (primary electromagnetic wave) output from the emitter 71 and emitted to the sample SP and the light (secondary electromagnetic wave) returning from the sample SP.

Among beams of the reflection light returned to the analysis optical system 7, the second beam splitter 78B further transmits reflection light transmitted through the first beam splitter 78A and plasma light transmitted through the first beam splitter 78A without reaching the first and second detectors 77A and 77B, and causes the reflection light and the plasma light to enter the first camera 81 via the imaging lens 80.

Although the coaxial illuminator 79 is incorporated in the analysis housing 70 in the example illustrated in FIG. 3, the present disclosure is not limited to such a configuration. For example, a light source may be laid out outside the analysis housing 70, and the light source and the analysis optical system 7 may be coupled to the optical system via an optical fiber cable.

The side illuminator 84 is arranged to surround the reflective object lens 74. The side illuminator 84 emits illumination light from the side of the sample SP (in other words, a direction tilted with respect to the analysis optical axis Aa) although not illustrated.

The first camera 81 receives the reflection light reflected by the sample SP via the reflective object lens 74. The first camera 81 captures an image of the sample SP by detecting a light reception amount of the received reflection light. The first camera 81 is an example of the “imaging section” in the present embodiment.

Specifically, the first camera 81 according to the present embodiment photoelectrically converts light incident through the imaging lens 80 by a plurality of pixels arranged on a light receiving surface thereof, and converts the light into an electrical signal corresponding to an optical image of a subject (the sample SP).

The first camera 81 may have a plurality of light receiving elements arranged along the light receiving surface. In this case, each of the light receiving elements corresponds to a pixel so that an electrical signal based on the light reception amount in each of the light receiving elements can be generated. Specifically, the first camera 81 according to the present embodiment is configured using an image sensor including a complementary metal oxide semiconductor (CMOS), but is not limited to this configuration. As the first camera 81, for example, an image sensor including a charged-coupled device (CCD) can also be used.

Then, the first camera 81 inputs an electrical signal generated by detecting the light reception amount by each light receiving element to the controller 21 of the controller main body 2. The controller 21 generates image data corresponding to the optical image of the subject based on the input electrical signal. The controller 21 can cause the display 22 or the like to display the image data thus generated as the image obtained by capturing the image of the subject.

The optical components that have been described so far are accommodated in the analysis housing 70. A through-hole 70a is provided in a lower surface of the analysis housing 70. The reflective object lens 74 faces the placement surface 51a via the through-hole 70a.

—Basic Principle of Analysis by Analysis Optical System 7—

The controller 21 executes component analysis of the sample SP based on the spectra input from the first detector 77A and the second detector 77B as detectors. As a specific analysis method, the LIBS method can be used as described above. The LIBS method is a method for analyzing a component contained in the sample SP at an element level (so-called elemental analysis method).

According to the LIBS method, vacuuming is unnecessary, and component analysis can be performed in the atmospheric open state. Further, although the sample SP is subjected to a destructive test, it is unnecessary to perform a treatment such as dissolving the entire sample SP so that position information of the sample SP remains (the test is only locally destructive).

—Observation Unit—

The observation unit includes the observation optical system 9 and the observation housing 90 in which the observation optical system 9 is accommodated. The observation optical system 9 is a set of components configured to observe the sample SP as the observation target, and the respective components are accommodated in the observation housing 90. The observation housing 90 is configured separately from the analysis housing 70 described above, and accommodates the second camera 93 as a second imaging section. Further, elements configured to observe the sample SP also include the controller 21 of the controller main body 2.

The observation optical system 9 includes a lens unit 9a having the objective lens 92. The lens unit 9a corresponds to a cylindrical lens barrel arranged on the lower end side of the observation housing 90. The lens unit 9a is held by the analysis housing 70.

A communication cable C2 configured to transmit and receive an electrical signal to and from the controller main body 2 and an optical fiber cable C3 configured to guide illumination light from the outside are connected to the observation housing 90. Note that the communication cable C2 is not essential, and the observation optical system 9 and the controller main body 2 may be connected by wireless communication.

Specifically, the observation optical system 9 includes a mirror group 91, the objective lens 92, the second camera 93 which is the second camera, a second coaxial illuminator 94, a second side illuminator 95, and a magnifying optical system 96 as illustrated in FIG. 2.

The objective lens 92 has the observation optical axis Ao extending along the substantially vertical direction, collects illumination light to be emitted to the sample SP placed on the placement stage main body 51, and collects light (reflection light) from the sample SP. The observation optical axis Ao is provided to be parallel to the analysis optical axis Aa of the reflective object lens 74 of the analysis optical system 7. The reflection light collected by the objective lens 92 is received by the second camera 93.

The mirror group 91 transmits the reflection light collected by the objective lens 92 to be guided to the second camera 93. The mirror group 91 according to the present embodiment can be configured using a total reflection mirror, a beam splitter, and the like as illustrated in FIG. 2. The mirror group 91 also reflects the illumination light emitted from the second coaxial illuminator 94 to be guided to the objective lens 92.

The second camera 93 receives the reflection light reflected by the sample SP via the objective lens 92. The second camera 93 captures an image of the sample SP by detecting a light reception amount of the received reflection light. The second camera 93 is an example of the “second imaging section (second camera)” in the present embodiment.

On the other hand, the first camera 81 is an example of the “first imaging section (first camera)” in the present embodiment as described above. Although a configuration in which the second camera 93 is regarded as the second imaging section and the first camera 81 is regarded as the first imaging section will be mainly described in the present specification, the first camera 81 may be regarded as the second imaging section and the second camera 93 may be regarded as the first second imaging section as will be described later. The second camera 93 according to the present embodiment includes an image sensor including a CMOS similarly to the first camera 81, but an image sensor including a CCD can also be used.

Then, the second camera 93 inputs an electrical signal generated by detecting the light reception amount by each light receiving element to the controller 21 of the controller main body 2. The controller 21 generates image data corresponding to the optical image of the subject based on the input electrical signal. The controller 21 can cause the display 22 or the like to display the image data thus generated as the image obtained by capturing the image of the subject.

The second coaxial illuminator 94 emits the illumination light guided from the optical fiber cable C3. The second coaxial illuminator 94 emits the illumination light through an optical path common to the reflection light collected through the objective lens 92. That is, the second coaxial illuminator 94 functions as a “coaxial epi-illuminator” coaxial with the observation optical axis Ao of the objective lens 92. Note that a light source may be incorporated in the lens unit 9a, instead of guiding the illumination light from the outside through the optical fiber cable C3. In that case, the optical fiber cable C3 is unnecessary.

As schematically illustrated in FIG. 2, the second side illuminator 95 is configured by a ring illuminator arranged so as to surround the objective lens 92. The second side illuminator 95 emits illumination light from obliquely above the sample SP similarly to the side illuminator 84 in the analysis optical system 7.

The magnifying optical system 96 is arranged between the mirror group 91 and the second camera 93, and is configured to be capable of changing an enlargement magnification of the sample SP by the second camera 93. The magnifying optical system 96 according to the present embodiment includes a variable magnification lens and an actuator configured to move the variable magnification lens along an optical axis of the second camera 93. The actuator can change the enlargement magnification of the sample SP by moving the variable magnification lens based on a control signal input from the controller 21.

Note that a specific configuration of the magnifying optical system 96 is not limited to the configuration in which the variable magnification lens is moved by the actuator. For example, the magnifying optical system may be provided with an operation section configured to move the variable magnification lens. In this case, the enlargement magnification of the sample SP can be changed as the operation section is operated by the user.

Further, the magnifying optical system may be provided with a sensor that detects switching of the enlargement magnification. Then, when it is detected that the enlargement magnification has been switched from a low magnification to a high magnification, an image before switching (a low-magnification image to be described later) may be automatically captured by the second camera 93, and the captured image may be stored in the controller main body 2. In this manner, the user can grasp a relative positional relation of a high-magnification image, which will be described later, with respect to the low-magnification image.

This magnifying optical system 96 may be configured to be capable of not only changing the enlargement magnification of the sample SP by the second camera 93 but also that changing an enlargement magnification of the sample SP by the first camera 81. In that case, the magnifying optical system 96 is provided between the dispersing element 75 and the first camera 81.

—Slide Mechanism 65—

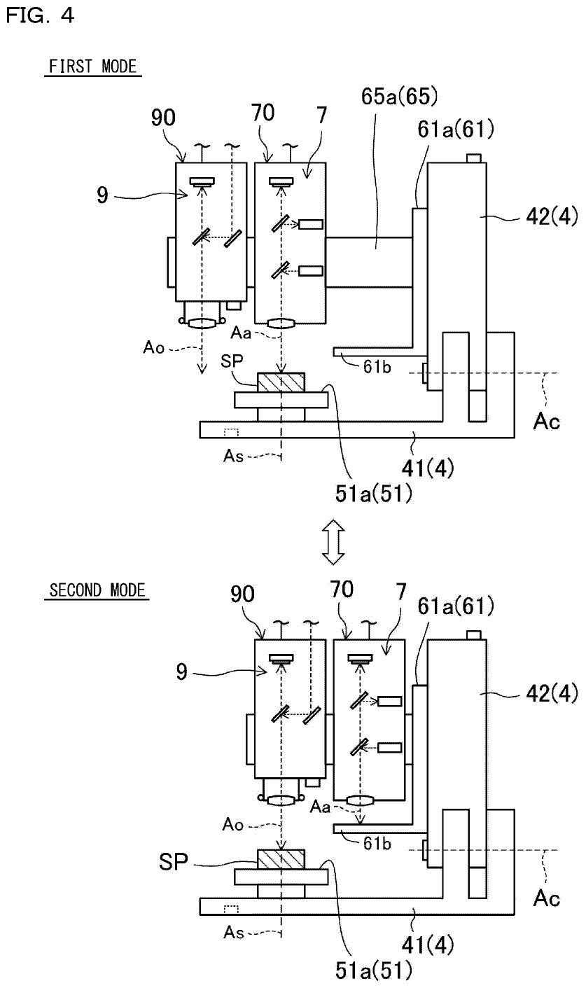

FIG. 4 is a view for describing the horizontal movement of the head 6 by the slide mechanism 65.

The slide mechanism 65 is configured to move the relative positions of the observation optical system 9 and the analysis optical system 7 with respect to the placement stage main body 51 along the horizontal direction such that the capturing of the sample SP by the observation optical system 9 and the irradiation of the electromagnetic wave (laser light) (in other words, the irradiation of the electromagnetic wave by the emitter 71 of the analysis optical system 7) in the case of generating the spectrum by the analysis optical system 7 can be performed on the identical point in the sample SP as the observation target.

The moving direction of the relative position by the slide mechanism 65 can be a direction in which the observation optical axis Ao and the analysis optical axis Aa are arranged. As illustrated in FIG. 4, the slide mechanism 65 according to the present embodiment moves the relative positions of the observation optical system 9 and the analysis optical system 7 with respect to the placement stage main body 51 along the front-rear direction.

The slide mechanism 65 according to the present embodiment relatively displaces the analysis housing 70 with respect to the stand 42 and the head attachment member 61. Since the analysis housing 70 and the lens unit 9a are coupled by the housing coupler 64, the lens unit 9a is also integrally displaced by displacing the analysis housing 70.

Specifically, the slide mechanism 65 according to the present embodiment includes the guide rail 65a and an actuator 65b, and the guide rail 65a is formed to protrude forward from a front surface of the head attachment member 61.

When the slide mechanism 65 is operated, the head 6 slides along the horizontal direction, and the relative positions of the observation optical system 9 and the analysis optical system 7 with respect to the placement stage 5 move (horizontally move) as illustrated in FIG. 4. This horizontal movement causes the head 6 to switch between a first mode in which the reflective object lens 74 faces the sample SP and a second mode in which the objective lens 92 faces the sample SP. The slide mechanism 65 can slide the analysis housing 70 and the observation housing 90 between the first mode and the second mode.

With the above configuration, the generation of the image of the sample SP by the observation optical system 9 and the generation of the spectrum by the analysis optical system 7 (specifically, the irradiation of the primary electromagnetic wave by the analysis optical system 7 when the spectrum is generated by the analysis optical system 7) can be executed on the identical point in the sample SP from the same direction at timings before and after performing the switching between the first mode and the second mode.

<Details of Controller Main Body>

FIG. 5 is a block diagram illustrating the configuration of the controller 21 of the controller main body 2. Note that the controller main body 2 and the optical system assembly 1 are configured separately in the present embodiment, but the present disclosure is not limited to such a configuration. At least a part of the controller main body 2 may be provided in the optical system assembly 1. For example, at least a part of the processor 21a constituting the controller 21 can be incorporated in the optical system assembly 1.

As described above, the controller main body 2 according to the present embodiment includes the controller 21 that performs various processes and the display 22 that displays information related to the processes performed by the controller 21.

The controller 21 electrically controls the actuator 65b, the coaxial illuminator 79, the side illuminator 84, the second coaxial illuminator 94, the second side illuminator 95, the first camera 81, the second camera 93, the overhead camera 48, the emitter 71, the first detector 77A, the second detector 77B, a lens sensor Sw1, the first tilt sensor Sw3, and the second tilt sensor Sw4.

Further, output signals of the first camera 81, the second camera 93, the overhead camera 48, the first detector 77A, the second detector 77B, the lens sensor Sw1, the first tilt sensor Sw3, and the second tilt sensor Sw are input to the controller 21. The controller 21 executes calculation or the like based on the input output signal, and executes processing based on a result of the calculation. As hardware for performing such processing, the controller 21 according to the present embodiment includes the processor 21a that executes various types of processing, a primary storage section 21b and the secondary storage section 21c that store data related to the processing performed by the processor 21a, and an input/output bus 21d.

The processor 21a includes a CPU, a system LSI, a DSP, and the like. The processor 21a executes various programs to analyze the sample SP and control the respective sections of the analysis and observation device A such as the display 22. In particular, the processor 21a according to the present embodiment can control a display screen on the display 22 based on information indicating the analysis result of the sample SP and pieces of the image data input from the first camera 81, the second camera 93, and the overhead camera 48.

Note that the display as a control target of the processor 21a is not limited to the display 22 provided in the controller main body 2. The “display” according to the present disclosure also includes a display that is not provided in the analysis and observation device A. For example, a display of a computer, a tablet terminal, or the like connected to the analysis and observation device A in a wired or wireless manner may be regarded as a display, and the information indicating the analysis result of the sample SP and various types of image data may be displayed on the display. In this manner, the present disclosure can also be applied to an analysis system including an analysis and observation device A and a display connected to the analysis and observation device A in a wired or wireless manner.

As illustrated in FIG. 5, the processor 21a according to the present embodiment includes, functional elements, a mode switcher 211, an illumination controller 212, an imaging processor 213, an emission controller 214, a spectrum acquirer 215, a component analysis section 216, a lens information acquirer 218, a tilt acquirer 219, a user interface controller (hereinafter simply referred to as “UI controller”) 221, an output section 222, an identifying section 223, an analysis record reader 224, a library reader 225, and a setting section 226. These elements may be implemented by a logic circuit or may be implemented by executing software. Further, at least some of these elements, such as the head 6, can also be provided in the optical system assembly 1.

Note that the classification of the spectrum acquirer 215, the component analysis section 216, and the like is merely for convenience and can be freely changed. For example, the component analysis section 216 may also serve as the spectrum acquirer 215, or the spectrum acquirer 215 may also serve as the component analysis section 216.

The UI controller 221 includes a display controller 221a and an input receiver 221b. The display controller 221a causes the display 22 to display a component analysis result obtained by the component analysis section 216 and an image generated by the imaging processor 213 on the display 22. The input receiver 221b receives an operation input by the user through the operation section 3.

The output section 222 outputs a spectrum acquired by a spectrum acquirer 215 and the component analysis result analyzed by the component analysis section 216 to an analysis history holding section 231.

The identifying section 223 identifies a similar analysis record similar to one analysis record from a plurality of analysis records held in the analysis history holding section 231.

The analysis record reader 224 reads the similar analysis record identified by the identifying section 223 and outputs the similar analysis record to the display controller 221a.

The library reader 225 reads a substance library LiS held in a library holding section 232 in order to estimate a substance by a substance estimator 216b.

The primary storage section 21b is configured using a volatile memory or a non-volatile memory. The primary storage section 21b according to the present embodiment can store various settings set by the setting section 226. Further, the primary storage section 21b can also hold an analysis program that executes each of steps constituting an analysis method according to the present embodiment.

The secondary storage section 21c is configured using a non-volatile memory such as a hard disk drive and a solid state drive. The secondary storage section 21c includes the analysis history holding section 231 that holds the analysis history and the library holding section 232 that holds the substance library LiS. Note that a data holding section that stores various types of data may be further included. The secondary storage section 21c can continuously store the analysis history and the substance library LiS. Note that the analysis history and the substance library LiS may be stored in a storage medium such as an optical disk instead of being stored in the secondary storage section 21c. Alternatively, various types of data may be stored in a computer, a tablet terminal, or the like connected to the analysis and observation device A in a wired or wireless manner. Further, the analysis history holding section 231 and the library holding section 232 may be configured using the same non-volatile memory or may be configured using different non-volatile memories.

1. Component Analysis of Sample SP

—Spectrum Acquirer 215—

The spectrum acquirer 215 illustrated in FIG. 5 acquires the spectra generated by the first and second detectors 77A and 77B as the detectors. Here, the spectra acquired by the spectrum acquirer 215 is an example of “analysis data”.

Specifically, in the first mode, a secondary electromagnetic wave (for example, plasma light) is generated by emitting a primary electromagnetic wave (for example, laser light) from the emitter 71. This secondary electromagnetic wave reaches the first detector 77A and the second detector 77B.

The first and second detectors 77A and 77B as the detectors generate the spectra based on the secondary electromagnetic waves arriving at each of them. The spectra thus generated are acquired by the spectrum acquirer 215. The spectra acquired by the spectrum acquirer 215 represent a relationship between a wavelength and an intensity, and there are a plurality of peaks corresponding to characteristics contained in the sample SP.

Although the analysis method using the LIBS method will be mainly described in the present embodiment, the present embodiment is not limited thereto. For example, mass spectrometry can be used as the analysis method. In this case, the analysis and observation device A can also detect the ionized sample SP by irradiating the sample SP with the primary electromagnetic wave or the primary ray. At that time, the emitter 71 irradiates an electron beam, a neutral atom, a laser beam, an ionized gas, and a plasma gas. The first and second detectors 77A and 77B can generate the spectrum based on m/z of the sample SP ionized by the primary electromagnetic wave or the primary ray (a dimensionless quantity obtained as a mass of ions is divided by unified atomic mass units and further divided by the number of charges of the ions) and the magnitude of a detection intensity for each m/z.

For example, in the case of using an electron ionization method (EI method) as the analysis method, the analysis and observation device A irradiates the sample SP with a thermal electron as the primary electromagnetic wave. The sample SP that has been irradiated with the thermal electron is ionized. The analysis and observation device A can analyze a characteristic of the sample SP based on a relationship between m/z of the ionized sample SP and its detection intensity. In this case, the spectrum acquirer 215 acquires a spectrum representing the relationship between m/z of the ionized sample SP and its detection intensity.

Further, in a case where an SEM/EDX method is used as the analysis method, the analysis and observation device A irradiates the sample SP with an electron beam as a primary ray. When the electron beam is emitted, a characteristic X-ray is generated in the sample SP. The first and second detectors 77A and 77B can generate spectra based on an energy level and an intensity of the generated characteristic X-ray. Further, in the case of using photothermal conversion infrared spectroscopy as the analysis method, the analysis and observation device A irradiates the sample SP with infrared light as the primary electromagnetic wave. The emitted infrared light is absorbed by the sample SP. A temperature change of the sample SP is generated due to the absorption of the primary electromagnetic wave, and thermal expansion is generated in response to the temperature change. The analysis and observation device A can analyze a characteristic of the sample SP based on a relationship between the magnitude of the thermal expansion of the sample SP and a wavelength corresponding to the thermal expansion. That is, in the case of using the photothermal conversion infrared spectroscopy, the first and second detectors 77A and 77B as the detectors generate the spectrum representing the relationship between each of wavelengths of the infrared light emitted to the sample SP and the magnitude of the thermal expansion of the temperature change generated for each of the wavelengths. Further, the spectrum acquirer 215 acquires the spectrum representing the relationship with the magnitude of the thermal expansion of the temperature change generated for each wavelength thus generated.

The spectrum acquired by the spectrum acquirer 215 in this manner is output to the analysis history holding section 231 by the output section 222 as one analysis data constituting the analysis record AR to be described later. Further, the spectrum acquired by the spectrum acquirer 215 is output to the component analysis section 216 in order to perform the component analysis of the sample SP.

—Component Analysis Section 216—

The component analysis section 216 illustrated in FIG. 5 identifies a peak position of a spectrum for executing the component analysis of the sample SP based on the spectrum acquired by the spectrum acquirer 215. Thus, it is possible to determine that an element corresponding to the peak position is a component contained in the sample SP, and it is also possible to determine component ratios of the respective elements and estimate the composition of the sample SP based on the determined component ratios by comparing magnitudes of peaks (heights of peaks).

The component analysis section 216 includes a characteristic estimator 216a and the substance estimator 216b. The characteristic estimator 216a estimates a characteristic Ch of a substance contained in the sample SP based on the spectrum acquired by the spectrum acquirer 215. For example, in a case where an analysis method mainly used for analysis of inorganic substances such as the LIBS method is used as the analysis method, the characteristic estimator 216a extracts a position of a peak in the acquired spectrum and a height of the peak. Then, the characteristic estimator 216a estimates a constituent element of the sample SP and a content of the constituent element as the characteristic Ch of the substance based on the peak position and the peak height thus extracted. Further, in a case where an analysis method mainly used for analysis of organic substances such as an IR method is used as the analysis method, the characteristic estimator 216a determines whether or not a peak exists in a predetermined wavelength region to estimate the presence or absence of a functional group. Since a wavelength region in which a peak corresponding to a specific functional group appears is known in advance, the presence or absence of the functional group can be estimated by determining whether or not a peak exists in the wavelength region in which the peak corresponding to the functional group appears.

The substance estimator 216b illustrated in FIG. 5 estimates the substance based on the characteristic Ch of the substance estimated by the characteristic estimator 216a and the substance library LiS held in the secondary storage section 21b. Here, the characteristic Ch of the substance estimated by the characteristic estimator 216a and the substance estimated by the substance estimator 216b are examples of “analysis data”.

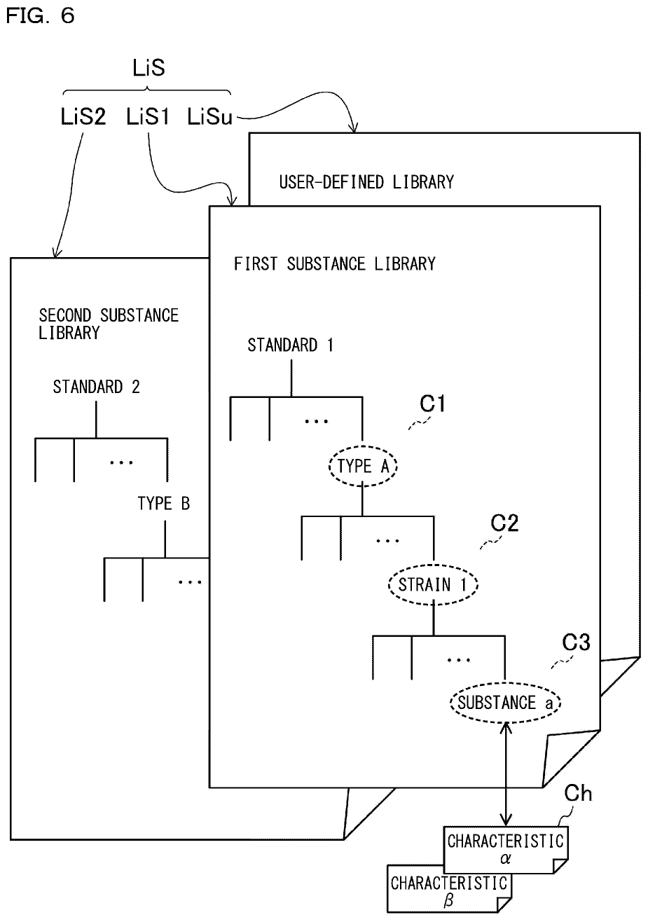

Here, the substance library LiS will be described with reference to FIG. 6. The substance library LiS includes pieces of hierarchical information of a superclass C1 representing a general term of substances considered to be contained in the sample SP and subclasses C3 representing the substances belonging to the superclass C1. The superclass C1 may include at least one or more of the subclasses C3 belonging thereto. Here, the superclass C1 is an example of information for identifying a substance.

For example, when the sample SP is a steel material, the superclass C1, which is the information for identifying a substance, may be a class such as alloy steel, carbon steel, and cast iron or may be a class, such as stainless steel, cemented carbide, and high-tensile steel, obtained by subdividing these classes.

Further, when the sample SP is the steel material, the subclass C3 may be a class such as austenitic stainless steel, precipitation hardening stainless steel, and ferritic stainless steel, or may be a class, such as SUS301 and SUS302, obtained by subdividing these classes based on, for example, Japanese Industrial Standards (JIS). The subclass C3 may be at least a class obtained by subdividing the superclass C1. In other words, the superclass C1 may be a class to which at least some of the subclasses C3 belong.

Further, one or more intermediate classes C2 may be provided between the superclass C1 and the subclass C3. In this case, the substance library LiS is configured by storing the hierarchical information of the intermediate class C2 together with pieces of the hierarchical information of the superclass C1 and the subclass C3. This intermediate classes C2 represent a plurality of strains belonging to the superclass C1. Here, the intermediate class C2 is an example of the information for identifying a substance.

For example, in a case where the sample SP is a steel material, classes such as stainless steel, cemented carbide, and high-tensile steel are used as the superclasses C1, which are the information for identifying a substance, and classes such as SUS301, SUS302, and A2017 are used as the subclasses C3, the intermediate class C2, which is the information for identifying a substance, may be a class such as austenitic and precipitation hardening, or may be a class collectively referring to some of the subclasses C3 such as “SUS300 series”.

Further, the subclass C3 constituting the substance library LiS is configured to be associated with the characteristic Ch of the substance considered to be contained in the sample SP. For example, in the case of using the LIBS method as the analysis method, the characteristic Ch of the substance contains information that summarizes a constituent element of the sample SP and a content (or content rate) of the constituent element in one set.

In this case, for each of substances constituting the subclass C3, a combination of constituent elements and an upper limit value and a lower limit value of a content (or a content rate) of each of the constituent elements are incorporated into the substance library Li, so that the subclass C3 can be estimated from the characteristic Ch of the substance as will be described later.

The secondary storage section 21c illustrated in FIG. 5 is configured using a non-volatile memory such as a hard disk drive and a solid state drive. The secondary storage section 21c can continuously store the substance libraries LiS. Note that the substance library LiS may be read from the outside, such as a storage medium 2000, instead of storing the substance library LiS in the secondary storage section 21c.

Further, the controller main body 2 can read the storage medium 2000 storing a program (see FIG. 5). In particular, the storage medium 2000 according to the present embodiment stores the analysis program for causing the analysis and observation device A to execute the respective steps constituting the analysis method according to the present embodiment. This analysis program is read and executed by the controller main body 2 which is a computer. As the controller main body 2 executes the analysis program, the analysis and observation device A functions as the analysis device that executes the respective steps of the analysis method according to the present embodiment.

As described above, the subclass C3 constituting the substance library LiS is configured to be associated with the characteristic Ch of the substance considered to be contained in the sample SP. Therefore, the substance estimator 216b collates the characteristic Ch of the substance estimated by the characteristic estimator 216a with the substance library LiS held in the secondary storage section 21b, thereby estimating, from subclass C3, the substance for which the characteristic Ch has been estimated. The collation here refers to not only calculating a similarity degree with representative data registered in the substance library LiS but also the general act of acquiring an index indicating the accuracy of a substance using the parameter group registered in the substance library LiS.

Here, not only a case where the subclass C3 and the characteristic Ch are uniquely linked like a “substance a” and a “characteristic a” illustrated in FIG. 6, but also a case where there are a plurality of candidates of the subclasses C3 corresponding to the “characteristic a” is conceivable. In that case, the characteristic estimator 216a estimates a plurality of substances each having a relatively high accuracy among substances that are likely to be contained in the sample SP from among the subclasses C3, and outputs the estimated subclasses C3 in descending order of the accuracy. Here, as the accuracy, an index based on a parameter obtained at the time of analyzing the spectrum can be used.

Further, the substance estimator 216b collates the estimated subclass C3 with the substance library LiS to estimate the intermediate class C2 and the superclass C1 to which the subclass C3 belongs. The characteristic Ch of the substance estimated by the characteristic estimator 216a and a characteristic estimated by the substance estimator 216b are output to the analysis history holding section 231 by the output section 222 as one data constituting the analysis record AR. Further, the characteristic Ch of the substance and the substance are output to the UI controller 221 and displayed on the display 22.

—Analysis Setting Section 226a—

An analysis setting section 226a illustrated in FIG. 5 receives various settings related to the analysis of the sample SP. In particular, it is possible to receive a weighting setting for a specific element in order to estimate a characteristic of the sample SP here.

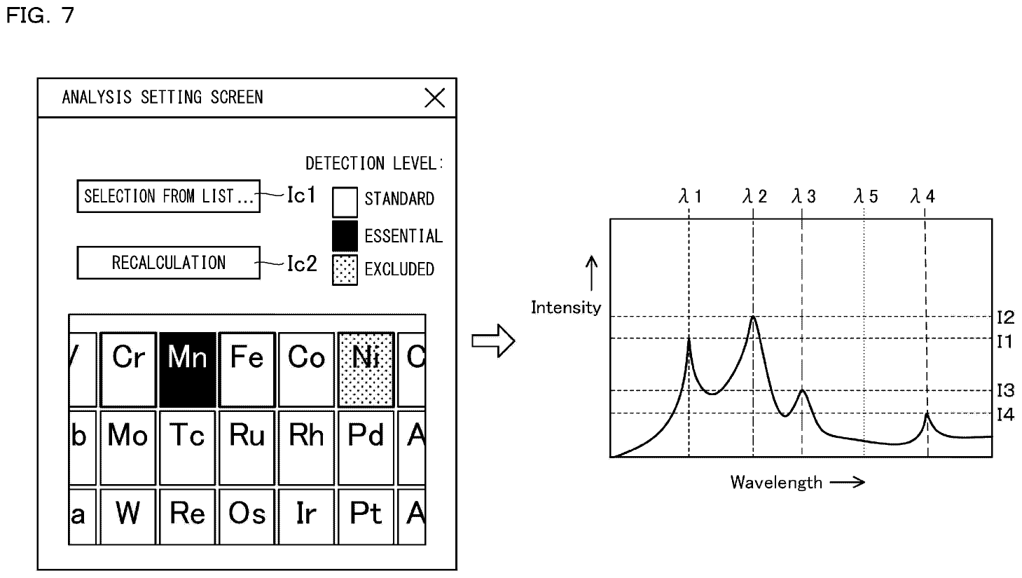

When receiving an analysis setting request by the input receiver 221b, the analysis setting section 226a generates an analysis setting screen. The analysis setting screen generated by the analysis setting section 226a is output to the display controller 221a. Then, the display controller 221a displays the analysis setting screen on the display 22. An example of the analysis setting screen displayed on the display 22 is illustrated on the left side of FIG. 7.

As in the example of FIG. 7, a periodic table (only a part of the periodic table is illustrated in the example illustrated in the drawing), a first icon Ic1 with a note “selection from list”, and a second icon Ic2 with a note “recalculation” can be displayed in the analysis setting screen.

Here, the input receiver 221b is configured to receive an operation input for each element in the periodic table displayed on the display. As illustrated in FIG. 7, each of the elements can be classified based on the operation input made for each of the elements into three types of detection levels including a standard item displaying an element name in black, an essential item displaying an element name in white, and an excluded item displaying an element name overlapping with a polka-dot pattern. When an operation input is performed on the second icon Ic2 in a state where the detection levels are set for the respective elements, the input receiver 221b having received the operation input instructs the component analysis section 216 to preform reanalysis. The component analysis section 216, which has been instructed to perform reanalysis, re-extracts a peak position and a peak height from the spectrum, and re-estimates a characteristic Ch and a substance. Note that the display controller 221a may cause the display 22 to display the updated peak position superimposed and displayed on the spectrum in response to the re-extraction of the peak position and the peak height by the component analysis section 216.

The detection level, which is a class of an element, will be described. An element classified as the standard item is detected as a detection element when its peak has been found in the spectrum. A position of the peak of the element detected as the detection element may be displayed to be distinguishable on the spectrum displayed on the display 22 by the display controller 221a.

Further, an element classified as the essential item is detected as a detection element constituting the characteristic Ch regardless of whether or not its peak is present in the spectrum. In the example illustrated in FIG. 7, manganese is classified as the essential item. In this case, the characteristic estimator 216a estimates a characteristic on the assumption that a peak is present at a position of a wavelength λ5 corresponding to manganese. Furthermore, the display controller 221a can superimpose and display the position of the wavelength λ5 corresponding to manganese on the spectrum. For example, when the sample SP does not contain manganese, a chain line indicating the wavelength λ5 is superimposed and displayed at a position where the peak does not appear in the spectrum as illustrated in FIG. 7.

Further, an element classified as the excluded item is excluded from detection elements constituting the characteristic Ch regardless of whether or not its peak is present in the spectrum. In the example illustrated in FIG. 7, nickel is classified as the excluded item. In this case, the characteristic estimator 216a estimates characteristics from the detection elements other than the excluded item on the assumption that the element classified as the excluded item is not included. Furthermore, a chain line indicating a wavelength corresponding to nickel is not displayed at a position of the peak corresponding to nickel regardless of the magnitude of a height of the peak, which is different from the spectrum exemplified in FIG. 7.

That is, when there is an element classified as the essential item, the characteristic estimator 216a re-estimates the characteristic Ch such that the element classified as the essential item is to be detected as a detection element constituting the characteristic regardless of whether or not a peak corresponding to the essential item is present in the spectrum. Further, when there is an element classified as the excluded item, the characteristic Ch is re-estimated such that the element classified as the excluded item is not to be detected as a detection element constituting the characteristic Ch regardless of whether or not a peak corresponding to the excluded item is present in the spectrum.

Further, when receiving an operation input for the first icon Ic1 illustrated in FIG. 7, the display controller 221a displays a list of the respective elements in a bulleted list on the display 22 (not illustrated). Then, the input receiver 221b can individually receive a class, such as the above-described standard item, essential item, and excluded item for each of the elements in the list.

The analysis setting set on the analysis setting screen is output to the primary storage section 21b. Further, the component analysis section 216 acquires the analysis setting stored in the primary storage section 21b, and estimates the characteristic Ch based on the analysis setting and the spectrum.

Note that the description has been given here regarding a method for classifying a plurality of elements into the standard item, the essential item, and the excluded item using the periodic table, but the present embodiment is not limited thereto. For example, in organic analysis using the IR method, instead of the elements, specific functional groups, such as a single bonds, double bonds, aromatic rings, hydroxy groups, and amino groups, or vibration types such as stretching vibrations and bending vibrations, may be classified into the standard item, the essential item, and the excluded item.

In this manner, the analysis setting section 226a can perform the setting so as to extract the essential item which is a characteristic that is recognized by the user as being included in an analyte in advance. A plurality of peaks are displayed on a spectrum. Therefore, it is sometimes difficult to accurately extract the essential item from the spectrum in a case where when a peak is present at a position slightly deviated from a peak corresponding to the essential item. Even in such a case, when the essential item is set in advance, it is possible to extract the characteristic that is recognized by the user as being included in the analyte in advance and to obtain a component analysis result that is closer to the user's expectations.

Further, the analysis setting section 226a can perform the setting such that the excluded item, which is a characteristic that is recognized by the user as not included in the analyte, is not to be extracted. A plurality of peaks are displayed on a spectrum. Therefore, in a case where a peak position deviates even slightly from an ideal position, there is a possibility that a different characteristic may be extracted instead of a characteristic that is to be originally extracted. When a characteristic that is recognized by the user as not included in the analyte in advance is set as the excluded item is set in advance, the excluded item can be excluded from extraction targets of the component analysis section. As a result, a characteristic can be extracted from characteristics other than the characteristic that is recognized by the user as not included in the analyte, and the component analysis result closer to the user's expectations can be obtained.

The analysis setting section 226a can also set a condition for component analysis by the component analysis section 216. For example, an intensity of an electromagnetic wave or a primary ray to be emitted from the emitter 71 and an integration time when a spectrum is acquired by the spectrum acquirer 215 can be received as the analysis setting.

<Component Analysis Flow>

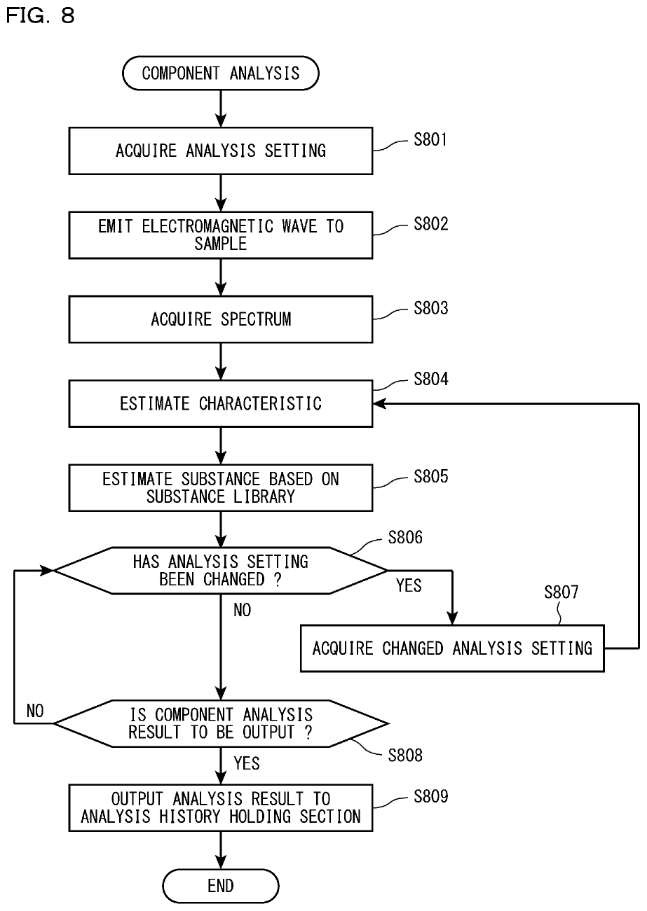

FIG. 8 is a flowchart illustrating an analysis procedure of the sample SP performed by the processor 21a.

First, in step S801, the component analysis section 216 acquires an analysis setting stored in the primary storage section. Note that this step can be skipped if the analysis setting has not been set in advance.

Next, in step S802, the emission controller 214 controls the emitter 71 based on the analysis setting set by the analysis setting section 226a, whereby an electromagnetic wave is emitted to the sample SP.

Next, in step S803, the spectrum acquirer 215 acquires a spectrum generated by the first and second detectors 77A and 77B. That is, plasma light caused by the electromagnetic wave emitted from the emitter 71 is received by the first and second detectors 77A and 77B. The first and second detectors 77A and 77B generate the spectrum which is an intensity distribution for each wavelength of the plasma light based on the analysis setting set by the analysis setting section 226a. The spectrum acquirer 215 acquires the spectrum, which is the analysis data, generated by the first and second detectors 77A and 77B.

In the subsequent step S804, the characteristic estimator 216a estimates the characteristic Ch of a substance contained in the sample SP based on the analysis setting and the spectrum acquired by the spectrum acquirer 215. In this example, the characteristic estimator 216a estimates a constituent element of the sample SP and a content of the constituent element as the characteristic Ch of the substance which is the analysis data. This estimation may be performed based on various physical models, may be performed through a calibration curve graph, or may be performed using a statistical method such as multiple regression analysis.

In the subsequent step S805, the substance estimator 216b estimates the substance contained in the sample SP (particularly the substance at a position irradiated with laser light) as the analysis data based on the characteristic Ch of the substance estimated by the characteristic estimator 216a. This estimation can be performed by the substance estimator 216b collating the characteristic Ch of the substance with the substance library LiS. At that time, two or more of the subclasses C3 may be estimated in descending order of the accuracy based on the accuracy (similarity degree) of the substance classified as the subclass C3 in the substance library LiS and the content of the constituent element estimated by the characteristic estimator 216a. Steps S803 to S805 are examples of an “analysis step” in the present embodiment.

In the subsequent step S806, the characteristic estimator 216a determines whether or not the analysis setting has been changed. The process proceeds to step S807 if the determination is YES, that is, the analysis setting has been changed, and proceeds to step S808 if the determination is NO, that is, the analysis setting has not been changed.

In step S807, the characteristic estimator 216a acquires the changed analysis setting from the analysis setting section 226a or the primary storage section 21b. Then, when the changed analysis setting is acquired, the characteristic estimator 216a returns to step S804 and re-estimates the characteristic Ch based on the changed analysis setting.

In step S808, it is determined whether or not to output a component analysis result. That is, the output section 222 determines whether or not the output of the component analysis result has been received from the input receiver 221b. Then, the process proceeds to step S809 if the determination is YES, and proceeds to step S806 if the determination is NO.

In step S809, the output section 222 outputs the component analysis result to the analysis history holding section 231 of the secondary storage section 21c. The analysis history holding section 231 holds a plurality of component analysis results obtained by the component analysis section 216. Here, the output section 222 outputs, to the analysis history holding section 231, the analysis record AR (analysis data) in which the characteristic Ch estimated by the characteristic estimator 216a as the component analysis result and the substance estimated by the substance estimator 216b are associated with each other. Further, one analysis record AR (analysis data) may include the spectrum used to estimate the characteristic Ch in association with the characteristic Ch which is the component analysis result and the substance. In this case, it is also possible to re-extract the characteristic Ch and re-evaluate the component analysis result based on the spectrum included in the analysis record AR.

Note that if the analysis history holding section 231 already holds the analysis record AR which is the component analysis result as an analysis history, the newly output analysis record AR is added to the existing analysis history. That is, the analysis history holding section 231 holds the analysis history in which a plurality of the analysis records are accumulated in response to the outputs of the analysis records AR from the output section 222. In this manner, the identifying section 223, which will be described later, can identify a component analysis result similar to the component analysis result obtained by the component analysis section 216 from among the component analysis results analyzed by the component analysis section 216 in the past.

2. Generation of Image of Sample SP

In the above description, it has been described that the component analysis of the sample SP is performed and the characteristic Ch, which is the component analysis result, is output to the analysis history holding section 231 as the analysis record AR. The output section 222 can also output a component analysis result to the analysis history holding section 231 in association with an image P obtained by capturing the sample SP as the analysis record AR. Here, the acquisition of the image P of the sample SP and the output to the analysis history holding section 231 as the analysis record AR will be described.

—Illumination Setting Section 226b—

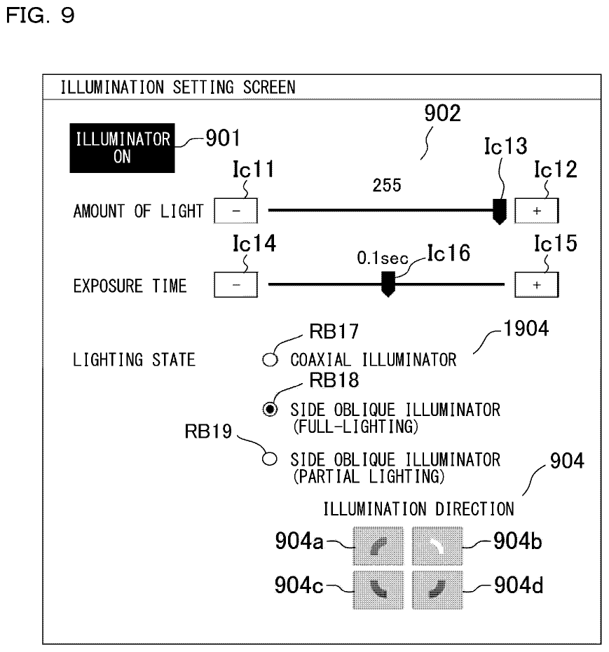

An illumination setting section 226b illustrated in FIG. 5 receives a setting of illumination conditions. The illumination conditions refer to control parameters related to the first camera 81, the coaxial illuminator 79 and the side illuminator 84, and control parameters related to the second camera 93, the second coaxial illuminator 94 and the second side illuminator 95. The illumination conditions include the amount of light of each illuminator, a lighting state of each illuminator, and the like. FIG. 9 illustrates an example of an illumination condition setting screen for receiving the setting of the illumination conditions.

The illumination condition setting screen includes a switch button 901 for switching ON/OFF of an illuminator, a light amount adjustment area 902 for adjusting the amount of light, an exposure time adjustment area 903 for adjusting an exposure time, and a lighting state setting area 904 for setting a lighting state of an illuminator.

The switch button 901 is, for example, a toggle type, and can switch an ON state and an OFF state of an illuminator according to the operation of the switch button 901. In the example illustrated in FIG. 9, the ON state is displayed in white letters on a black background. Although not illustrated, the OFF state can be displayed in black letters on a white background.

The light amount adjustment area 902 includes an icon Ic11 for reducing the amount of light, an icon Ic12 for increasing the amount of light, and an icon Ic13 for indicating the relative magnitude of the currently set amount of light within a settable range. Furthermore, the currently set amount of light is displayed in a numerical value above the icon Ic13. The amount of light can be changed according to a click of Ic11 or Ic12 or by moving Ic13 in the left-right direction.

The exposure time adjustment area 1903 includes an icon Ic14 for decreasing the exposure time, an icon Ic15 for increasing the exposure time, and an icon Ic16 for indicating the relative magnitude of a currently set exposure time within a settable range. Furthermore, the currently set exposure time is displayed in a numerical value above the icon Ic16. The exposure time can be changed in according to a click of Ic14 or Ic15 or by moving Ic16 in the left-right direction.

The lighting state setting area 904 includes a radio button 17 for lighting the coaxial illuminator 79 or the second coaxial illuminator 94, and radio buttons RB18 and RB19 for fully or partially lighting the side illuminator 84 or the second side illuminator 95. When the radio button 19 is selected, it is possible to further select which direction of a light source is to be lit. In the example illustrated in FIG. 9, panels 904a, 904b, 904c, and 904d that imitate side illuminators divided in four directions are displayed as an example. It is possible to switch ON/OFF of the illuminator in a direction corresponding to each of the panels by selecting each of the panels. Further, the illumination setting set by the illumination setting section 226b is output to the analysis history holding section 231 by the output section 212 as one data constituting the analysis record AR.

—Illumination Controller 212—

The illumination controller 212 illustrated in FIG. 5 reads the illumination conditions set by the illumination setting section 226b from the primary storage section 21b or the secondary storage section 21c, and controls at least one of the coaxial illuminator 79, the side illuminator 84, the second coaxial illuminator 94, and the second side illuminator 95 so as to reflect the read illumination conditions. With this control, the illumination controller 212 can turn on at least one of the coaxial illuminator 79 and the side illuminator 84 or turn on at least one of the second coaxial illuminator 94 and the second side illuminator 95.

—Lens Information Acquirer 218—

The lens information acquirer 218 illustrated in FIG. 5 acquires lens information related to the lens unit 9a based on a detection signal of the lens sensor Sw1. The lens information may include, for example, a lens name of the lens unit, an enlargement magnification, a working distance (WD), and the like. Further, the lens information acquired by the lens information acquirer 218 is output to the analysis history holding section 231 by the output section 222 as one data constituting the analysis record AR.

—Tilt Acquirer 219—

The tilt acquirer 219 illustrated in FIG. 5 acquires a tilt angle θ detected by the first tilt sensor Sw3 and the second tilt sensor Sw4. Further, the tilt angle θ acquired by the tilt acquirer 219 is output to the analysis history holding section 231 by the output section 222 as one data constituting the analysis record AR.

—Imaging Processor 213—

The imaging processor 213 illustrated in FIG. 5 receives an electrical signal generated by at least one camera of the first camera 81, the second camera 93, and the overhead camera 48, and generates the image P of the sample SP. The image P generated by the imaging processor 213 is output to the analysis history holding section 231 by the output section 222 as one analysis data constituting the analysis record AR.

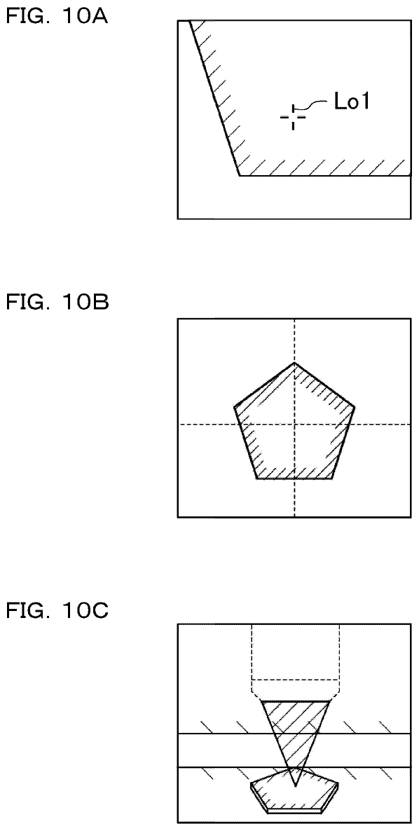

An example of the image P generated by the first camera 81 is illustrated in FIG. 10A. The first camera 81 can observe the sample SP at a higher magnification than the second camera 93, which will be described later, in order to observe an analysis point of the sample SP in detail. When the sample SP is observed at a high magnification, the image P generated by the imaging processor 213 can be referred to as a high-magnification image if focusing on the magnification of the first camera 81. In this case, a visual field range of the first camera 81 (imaging visual field) is narrower than that of the second camera 93. Therefore, an image generated by the imaging processor 213 can be referred to as a narrow-area image when focusing on the visual field range (imaging visual field) of the first camera 81. Note that the image captured by the first camera 81 may be referred to as a pre-irradiation image Pb or a post-irradiation image Pa depending on an imaging timing thereof. The pre-irradiation image Pb refers to the image P before the sample SP is irradiated with laser light, and the post-irradiation image Pa refers to the image P after the sample SP is irradiated with the laser light.

An example of the image P generated by the second camera 93 is illustrated in FIG. 10B. The imaging section configured to capture an image of the sample SP is switched between the first camera 81 and the second camera 93 by the mode switcher 211 to be described later. The second camera 93 can observe the sample SP at a lower magnification than that of the first camera 81 in order to observe the entire sample SP. When the sample SP is observed at a low magnification, the image P generated by the imaging processor 213 can be referred to as a low-magnification image if focusing on the magnification of the second camera 93. In this case, a visual field range of the second camera 93 (imaging visual field) is wider than that of the first camera 81. Therefore, an image generated by the imaging processor 213 can be referred to as a wide-area image when focusing on the visual field range (imaging visual field) of the second camera 93. Here, the names such as such the high-magnification image and the narrow-area image are used for the purpose of description, and the present embodiment is not limited thereto.

Note that the wide-area image can also be generated based on the electrical signal generated by the first camera 81. As an example, the imaging processor 213 generates a high-magnification image based on the electrical signal generated by the first camera 81. Then, the imaging processor 213 generates a plurality of high-magnification images while changing relative positions of the first camera 81 and the sample SP. Then, the imaging processor 213 pastes the plurality of high-magnification images together based on a relative positional relationship between the first camera 81 and the sample SP at the time of generating one high-magnification image. As a result, the imaging processor 213 can also generate a wide-area image having a wider visual field range than the each of the high-magnification images.

An example of the image generated by the overhead camera 48 is illustrated in FIG. 10C. A bird's-eye view image Pf in the present embodiment corresponds to the image P of the sample SP viewed from the side. Note that the overhead camera 48 is an example of the “second imaging section” in the present embodiment.

Further, the bird's-eye view image Pf is an image having a wider visual field range (imaging visual field) than the high-magnification image generated based on the electrical signal generated by the first camera 81, and thus, can be classified as one of the above-described wide-area images.

That is, the wide-area image referred to in the present specification indicates at least one of the image P generated by pasting the plurality of high-magnification images together, the image P generated based on a light reception signal generated by the second camera 93, and the bird's-eye view images Pf generated by the overhead camera 48.

—Mode Switcher 211—

The mode switcher 211 illustrated in FIG. 5 switches from the first mode to the second mode or switches from the second mode to the first mode by advancing and retracting the analysis optical system 7 and the observation optical system 9 along the horizontal direction (the front-rear direction in the present embodiment). For example, the mode switcher 211 according to the present embodiment can switch to one of the second camera 93 and the first camera 81 by moving the observation housing 90 and the analysis housing 70 relative to the placement stage 5.

The mode switcher 211 can switch to one of the first camera 81 and the second camera 93 as the imaging section configured to capture the image of the sample SP. For example, the mode switcher 211 is set to the first camera 81 as the imaging section in the first mode, and is set to the second camera 93 as the imaging section in the second mode in the present embodiment.

Specifically, the mode switcher 211 according to the present embodiment reads, in advance, the distance between the observation optical axis Ao and the analysis optical axis Aa stored in advance in the secondary storage section 21c. Next, the mode switcher 211 operates the actuator 65b of the slide mechanism 65 to advance and retract the analysis optical system 7 and the observation optical system 9.

<Acquisition Condition>

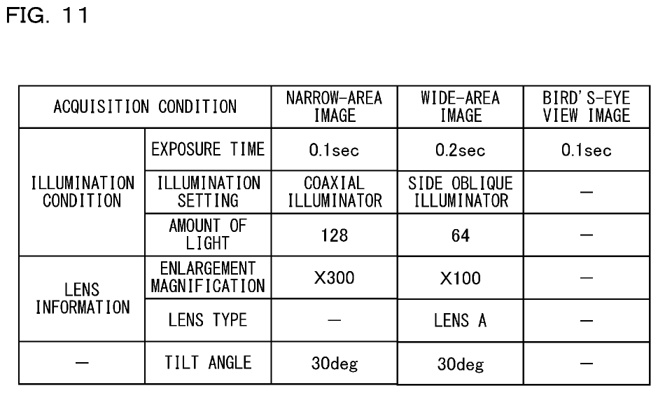

Here, acquisition conditions when the image P of the sample SP has been generated will be described. The acquisition conditions include the illumination setting, the lens information, and the tilt angle θ when the image P of the sample SP has been generated, and indicate various parameters related to the image P of the sample SP. FIG. 11 illustrates examples of the acquisition conditions.

Here, the acquisition conditions include the exposure time included in the illumination conditions, the illumination setting, the amount of light, the enlargement magnification included in the lens information, a lens type, and the tilt angle θ.

The exposure time, the illumination setting, and the amount of light included in the illumination conditions are set by the illumination setting section 226b. Further, the enlargement magnification and the lens type included in the lens information are acquired by the lens information acquirer 218. Then, the tilt angle θ is acquired by the tilt acquirer 219.

In the present embodiment, parameters related to the image P of the sample SP, such as the exposure time: 0.1 sec, the illumination setting: the coaxial illuminator, the amount of light: 128, the enlargement magnification: 300 times, and the tilt angle: 30 degrees, can be stored in association with the image P of the sample SP as the acquisition conditions. In this manner, each of the acquisition conditions, which are the parameters related to the image P of the sample SP, is output to the analysis history holding section 231 by the output section 222 in association with the image P of the sample SP as analysis data constituting the analysis record AR.

<Flow of Performing Image Generation and Component Analysis of Sample SP>

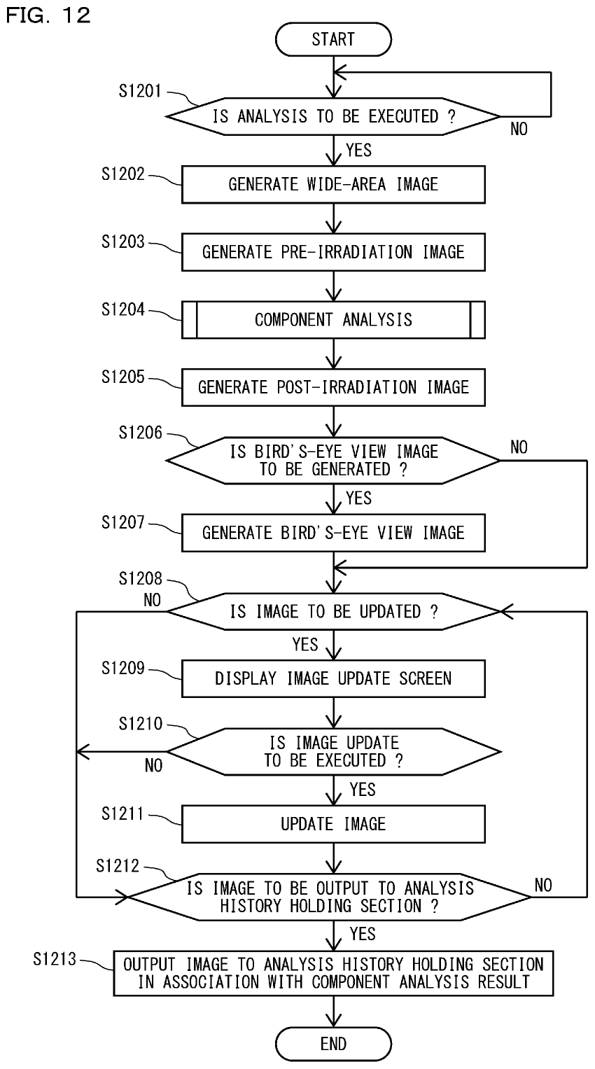

A process of capturing an image of the sample SP and generating the image P and a process of performing the component analysis of the sample SP will be described with reference to a flowchart of FIG. 12. First, in step S1201, the input receiver 221b determines whether or not an operation for executing analysis has been performed, the control process proceeds to step S1202 in the case of YES in this determination, and the determination in S1201 is repeated in the case of NO.

Subsequently, in step S1202, the imaging processor 213 generates a wide-area image. The wide-area image may be generated by pasting a plurality of high-magnification images together based on a light reception signal generated by the first camera 81, or may be generated based on a light reception signal generated by the second camera 93. Further, in step S1202, the imaging processor 213 acquires acquisition conditions of the wide-area image. That is, the imaging processor 213 acquires illumination conditions from the illumination setting section 226b or the primary storage section 21b, acquires lens information from the lens information acquirer 218, and acquires the tilt angle θ from the tilt acquirer 219. Then, the imaging processor 213 associates the acquired acquisition conditions with the wide-area image.

Subsequently, in step S1203, the imaging processor 213 generates the pre-irradiation image Pb of the sample SP. The pre-irradiation image Pb is generated based on an electrical signal generated by the first camera 81 or the second camera 93. Further, in step S1203, the imaging processor 213 acquires acquisition conditions of the pre-irradiation image Pb, and associates the acquired acquisition conditions with the pre-irradiation image Pb. Details are the same as those of S2102, and thus, will be omitted.

Subsequently, in step S1204, the component analysis of the sample SP is performed. A procedure of the component analysis of the sample SP is the same as that in FIG. 8.

Subsequently, in step S1205, the imaging processor 213 generates the post-irradiation image Pa of the sample SP. The post-irradiation image is generated based on an electrical signal generated by the first camera 81. Further, in step S1205, the imaging processor 213 acquires acquisition conditions of the post-irradiation image Pa, and associates the acquired acquisition conditions with the post-irradiation image Pa.

Subsequently, in step S1206, the input receiver 221b determines whether or not an operation for capturing the bird's-eye view image Pf has been performed, and the control process proceeds to step S1207 in the case of YES in this determination and proceeds to step S1212 in the case of NO.

In step S1207, the imaging processor 213 generates the bird's-eye view image Pf. The bird's-eye view image Pf is generated based on an electrical signal generated by the overhead camera 48. Further, in step S1207, the imaging processor 213 acquires acquisition conditions of the bird's-eye view image Pf, and associates the acquired acquisition conditions with the bird's-eye view image Pf.

Subsequently, in step S1208, the input receiver 221b determines whether or not an operation for updating the image P has been performed, and the control process proceeds to step S1209 in the case of YES in this determination and proceeds to step S1212 in the case of NO.

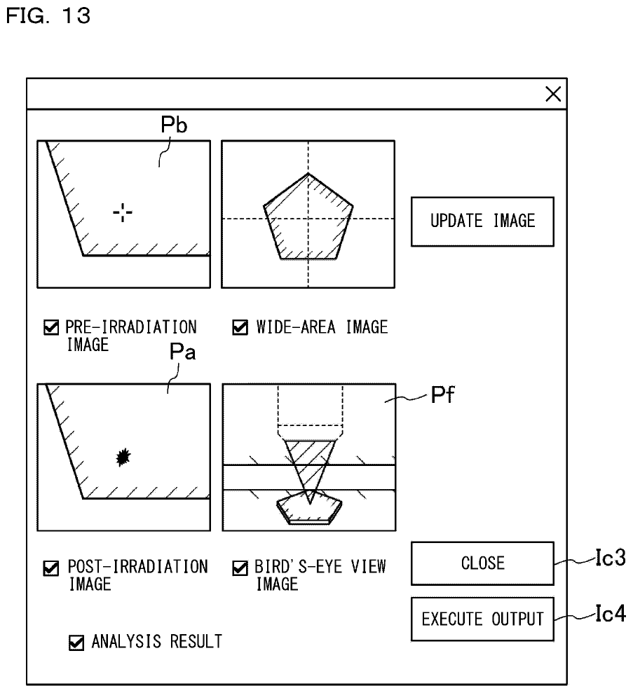

When the operation for updating the image P has been performed in step S1208, the display controller 221a causes the display 22 to display an output image selection screen as illustrated in FIG. 13 in step S1209. Then, the input receiver 221b receives selection of one image from the image P displayed on the output image selection screen.

In the subsequent step S1210, the input receiver 221b detects whether or not the operation for updating the image P has been performed, and the control process proceeds to step S1211 in the case of YES in this determination and proceeds to step S1212 in the case of NO.

In step S1211, the imaging processor 213 updates the image selected on the output image selection screen.

Subsequently, in step S1212, the input receiver 221b determines whether or not an operation for outputting a component analysis result has been performed, the control process proceeds to step S1213 in the case of YES in this determination, and returns to step S1208 in the case of NO. This determination can be made, for example, based on whether or not an output execution icon Ic4 displayed on the display 22 has been clicked.

In step S1213, the output section 222 outputs the image P to the analysis history holding section 231 of the secondary storage section 21c in association with the component analysis result. Here, the image P output to the analysis history holding section 231 is at least one of the wide-area image, the pre-irradiation image Pb, the post-irradiation image Pa, and the bird's-eye view image Pf each of which is associated with the acquisition conditions, and there is no need to output all the images. Further, in the output of the image P, check boxes may be provided respectively for the wide-area image, the pre-irradiation image Pb, the post-irradiation image Pa, and the bird's-eye view image Pf, as illustrated in FIG. 13, so as to output only the image P that has been checked through the input receiver 221b. That is, the output image selection screen may be provided for selecting which image P is to be output from the plurality of images P such as the wide-area image, the pre-irradiation image Pb, the post-irradiation image Pa, and the bird's-eye view image Pf. Note that the output image selection screen may be further provided with a check box for selecting whether or not to output an analysis result, and the output of the analysis result may be selected according to a selection state of the check box.

3. Analysis Record (Analysis Data)

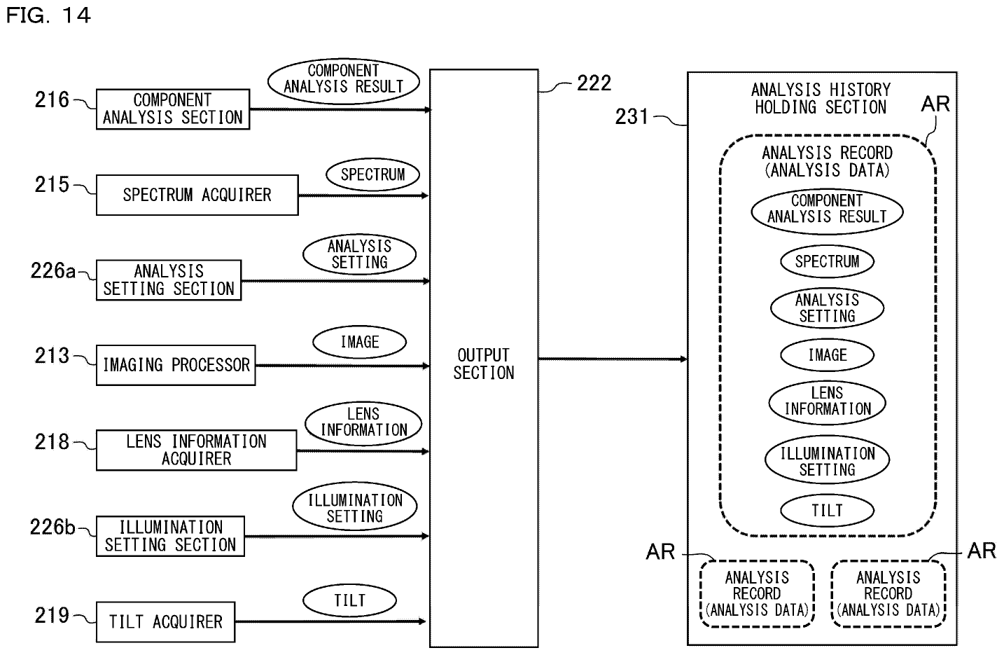

Here, the analysis record (analysis data) AR output by the output section 222 and held in the analysis history holding section 231 will be described with reference to FIG. 14.

The analysis record AR includes various types of analysis data such as the analysis setting and the component analysis result output from the output section 222 to the analysis history holding section 231. Specifically, the component analysis section 216 performs component analysis based on a spectrum acquired by the spectrum acquirer 215. Then, the component analysis section 216 outputs the component analysis result, which is a result of the component analysis, to the output section 222. Note that the component analysis result may include both the characteristic Ch estimated by the characteristic estimator 216a based on the spectrum and a characteristic estimated based on the characteristic Ch. Then, the output section 222 acquires the spectrum used to obtain the component analysis result from the spectrum acquirer 215, and associates the spectrum with the component analysis result.

Furthermore, the output section 222 acquires an analysis setting used to obtain the component analysis result from the analysis setting section 226a, and associates the analysis setting with the component analysis result.

That is, the output section 222 associates not only the component analysis result obtained by the component analysis section 216 but also the spectrum and the analysis setting, which are basic data used to obtain the component analysis result, with the component analysis result. As a result, the user can grasp under what conditions the component analysis has been performed, and further, can evaluate the validity of the component analysis result again.

Next, the output section 222 acquires the image P of the sample SP, generated by the imaging processor 213 based on an electrical signal generated by the imaging section at the time of acquiring the component analysis result, and associates the component analysis result with the image P.

The image P acquired here includes at least one of the above-described wide-area image, pre-irradiation image Pb, post-irradiation image Pa, and bird's-eye view image Pf. The wide-area image is the image P obtained by capturing the sample SP using the first camera 81 or the second camera 93. The pre-irradiation image Pb is the image P captured by the first camera 81 as the imaging section before the component analysis of the sample SP is executed. Further, the post-irradiation image Pa is the image captured by the first camera 81 as the imaging section after the execution of component analysis of the sample SP. Furthermore, the bird's-eye view image Pf is the image P captured by the overhead camera 48. Note that, the pre-irradiation image Pb and the post-irradiation image Pa are referred to for convenience of the description, but do not uniquely specify the context with an irradiation timing of laser light of the emitter 71. The pre-irradiation image Pb can include the image P obtained by updating the image P acquired before the irradiation of the laser light by the emitter 71 is with the image P acquired after the irradiation. That is, the pre-irradiation image Pa includes the image P assigned by the user as the pre-irradiation image Pa even if the image has been captured after the irradiation of the laser light by the emitter 71. Note that the image P associated with the component analysis result includes at least the image selected by the output image selection screen as illustrated in FIG. 13 as described above.

In general component analysis, only a component analysis result of the sample SP is stored.

Therefore, it is difficult for the user to grasp which sample SP has been analyzed to obtain the result. However, when the component analysis result is associated with the image P obtained at the time of acquiring the component analysis result, it is possible to easily grasp which sample SP has been acquired for the component analysis result.

Further, the output section 222 acquires, from the lens information acquirer 218, lens information at the time of acquiring the image P and associates the image P with the lens information. Similarly, the output section 222 acquires, from the illumination setting section 226b, at the time of acquiring an illumination setting and associates the image P with the illumination setting. Furthermore, the output section 222, the tilt acquirer 219, acquires the tilt angle θ at the time of acquiring the image, and associates the image P with the tilt angle θ.

Here, since the image P acquired by the imaging section is associated with the component analysis result, the lens information, the illumination setting, and the tilt angle θ are also associated with the component analysis result.

As described above, the output section 222 uses the component analysis result, obtained by the component analysis section 216, as a master key, and associates the component analysis result with the spectrum, the analysis setting, the image P, the lens information, the illumination setting, and the tilt angle θ which are pieces of the analysis data. The spectrum, analysis setting, image P, lens information, illumination setting, and tilt angle θ associated with the component analysis result as the master key indicate under what conditions the component analysis has been performed, and can be also referred to as the basic data.

As a result, it is easier for the user to understand under what conditions one component analysis result has been obtained by analyzing which sample SP, and which is suitable to confirm the component analysis result.

Then, the output section 222 outputs the one component analysis result and the basic data corresponding to the one component analysis result to the analysis history holding section 231 as one analysis record AR.

The analysis history holding section 231 holds the one analysis record AR output from the output section 222 and added the existing analysis record AR. That is, the analysis history holding section 231 accumulates the analysis records AR output by the output section 222 and holds the accumulated analysis records AR as a history of the component analysis results obtained by the component analysis section 216.

4. Identification of Similar Analysis Record SAR

The identifying section 223 can identify a similar analysis record SAR similar to one component analysis result from among a plurality of the analysis records AR held in the analysis history holding section 231. Here, the identification of the similar analysis record SAR by the identifying section 223 will be described.

<Identification of Similar Analysis Record SAR Based on Component Analysis Result>

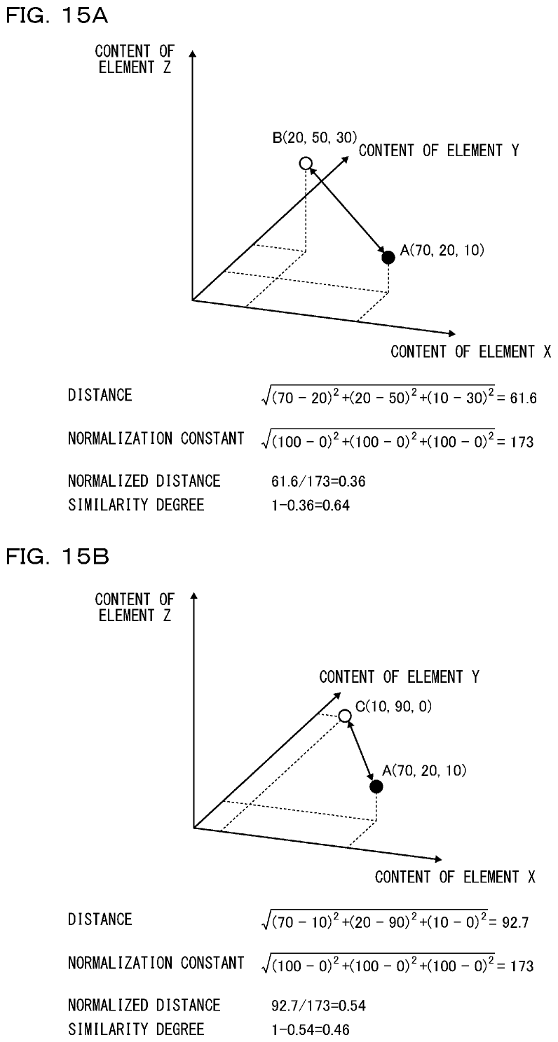

FIGS. 15A and 15B are views for describing a method for identifying the similar analysis record SAR based on the component analysis result.

One analysis record AR includes a component analysis result which is a master key. The identifying section 223 can identify the similar analysis record SAR using this component analysis result. Here, as an example, a description will be given regarding a method for identifying a component analysis result similar to one component analysis result obtained by the component analysis section 216 from among the plurality of component analysis results held in the analysis history holding section 231. The analysis history holding section 231 holds the analysis record AR in which the component analysis result as the master key is associated with the plurality of pieces of basic data. Here, a method for identifying a component analysis result similar to one component analysis result using the component analysis result included in the analysis record AR will be described first. Note that a component analysis result held in the analysis history holding section 231 and the analysis record AR including the component analysis result are read out by the analysis record reader 224 illustrated in FIG. 5.

One component analysis result, which serves as a comparison reference among component analysis results, is indicated by a black circle in FIG. 15A and FIG. 15B. The one component analysis is referred to as a component analysis result A, and contents of an element X, an element Y, and an element Z are estimated to be 70%, 20%, and 10%, respectively, as the characteristics Ch. Further, component analysis results, which serve as comparison targets among the component analysis results, are indicated by white circles in FIG. 15A and FIG. 15B, respectively. The component analysis result as the comparison target indicated by the white circle in FIG. 15A is referred to as a component analysis result B, and contents of the element X, the element Y, and the element Z are estimated to be 20%, 50%, and 30%, respectively, as the characteristics Ch. Further, the component analysis result as the comparison target indicated by the white circle in FIG. 15B is referred to as a component analysis result C, and contents of the element X and the element Y are estimated to be 10% and 90%, respectively, as the characteristics Ch. That is, it is estimated that the component analysis result C does not contain the element Z.

The identifying section 223 can use a distance on a multi-dimensional space, which has the elements constituting the respective component analysis results as coordinate axes, in order to identify a component analysis result similar to the component analysis result A. That is, the identifying section 223 can calculate a similarity degree based on the distance between the component analysis results in the multi-dimensional space, and identify a component analysis result having a high similarity degree as the component analysis result similar to the component analysis result A.

Specifically, the component analysis results A to C are formed using three types of elements of the element X, the element Y, and the element Z, and thus, a three-dimensional space having the element X, the element Y, and the element Z as coordinate axes, respectively, is conceivable. In this case, a distance between the component analysis result A and the component analysis result B is 61.6 as illustrated in FIG. 15A. This distance is divided by a predetermined normalization constant, configured for normalization, to obtain a normalized distance. The closer the distance is, the higher the similarity is. Thus, the identifying section 223 calculates 0.64, which is obtained by subtracting the normalized distance from 1, as a similarity degree. Similarly, the identifying section 223 calculates a similarity degree between the component analysis result A and the component analysis result C as 0.46. In this case, it is determined that the component analysis result A has the shorter distance from the component analysis result B than the component analysis result C and has the higher similarity degree. Therefore, the identifying section 223 can identify the component analysis result B out of the component analysis result B and the component analysis result C as the component analysis result similar to the component analysis result A. Note that the normalization process is not always necessary, and it is sufficient for the identifying section 223 to determine the similarity based on at least the distance between component analysis results.

Here, the method for identifying a component analysis result similar to one component analysis result from among the plurality of component analysis results held in the analysis history holding section 231 has been described, but it is also possible to identify the similar analysis record SAR having a component analysis result similar to one component analysis result.

That is, the identifying section 223 can calculate distances, from one component analysis result, of component analysis results respectively included in the plurality of analysis records AR held in the analysis history holding section 231, and obtain similarity degrees based on the calculated distances. Then, the identifying section 223 can identify the analysis record AR having a component analysis result having a high similarity degree as the similar analysis record SAR. Note that the similarity degree based on the component analysis result calculated here is an example of an “analysis similarity degree” in the present embodiment. Note that the similarity degree can be also calculated in consideration of not only the component analysis result but also a similarity degree of an analysis setting, a similarity degree of an image, a similarity degree of an acquisition condition, and a similarity degree of a shape a spectrum itself.

<Identification of Similar Analysis Record SAR Using Analysis Setting>

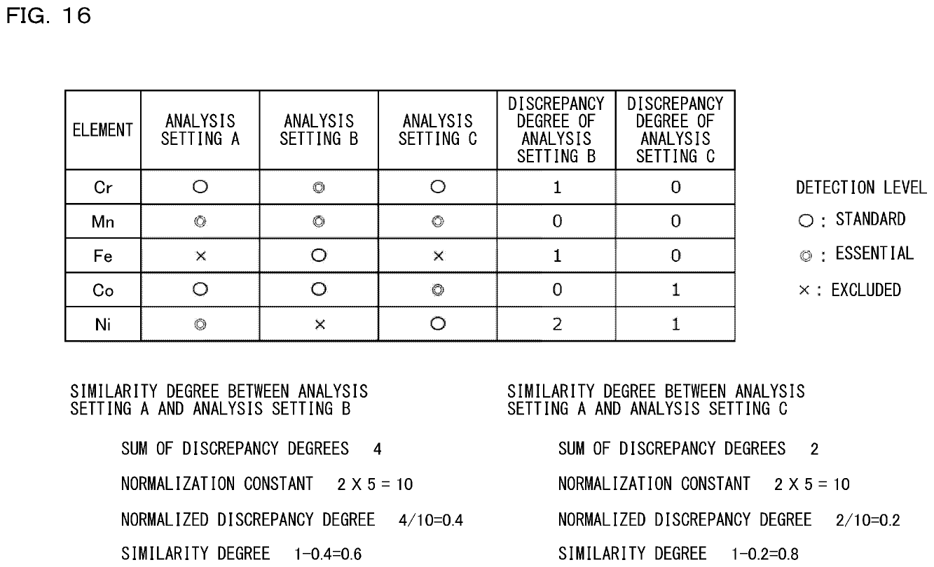

FIG. 16 is a view illustrating a method for identifying the similar analysis record SAR based on the analysis setting included in the analysis record AR. One analysis record AR includes an analysis setting associated with a component analysis result which is a master key. The identifying section 223 can identify the similar analysis record SAR using this analysis setting. Here, as an example, a description will be given regarding a method for identifying an analysis setting similar to an analysis setting A associated with the above-described component analysis result A out of an analysis setting B and an analysis setting C corresponding to the component analysis result B and the component analysis result C, respectively. As illustrated in FIG. 16, Mn and Ni as the essential items and Fe as the excluded item are set in the analysis setting A. Further, Cr and Mn as the essential items and Ni as the excluded item are set in the analysis setting B. Then, Mn and Co as the essential items and Fe as the excluded item are set in the analysis setting C.

As an example, a method in which the identifying section 223 calculates a similarity degree according to a difference between the standard item, the essential item, and the excluded item will be described focusing on Cr as an element. Cr is classified as the standard item in the analysis setting A and classified as the essential item in the analysis setting B. That is, there is a one-level discrepancy between the analysis setting A and the analysis setting B. On the other hand, Cr is classified as the standard item in the analysis setting C, and there is no discrepancy between the analysis setting A and the analysis setting C. In this manner, the discrepancy between the standard item, the essential item, and the excluded item can be quantified (digitized) to calculate the similarity degree. It is possible to quantify a discrepancy degree between analysis settings, for example, by setting a discrepancy degree to 1 in a case where there is a one-level discrepancy such as between the essential item and the standard item and between the standard item and the excluded item, and setting a discrepancy degree to 2 in a case where there is a two-level discrepancy such as between the essential item and the excluded item. In this case, for Cr, the discrepancy degree between the analysis setting A and the analysis setting B is 1, and the discrepancy degree between the analysis setting A and the analysis setting C is 0.

In this manner, the identifying section 223 quantifies discrepancy degrees for the other elements and calculates a sum of the discrepancy degrees. In the example illustrated in FIG. 16, a sum of discrepancy degrees of the analysis setting B is 4, and a sum of discrepancy degrees of the analysis setting C is 2.

Next, the identifying section 223 normalizes the discrepancy degree. As a normalization constant for normalizing the discrepancy degree, for example, a product of a maximum discrepancy degree per element and the number of elements included in the analysis settings can be used.

Then, the identifying section 223 calculates a normalized discrepancy degree obtained by normalizing the sum of discrepancy degrees. Further, the analysis settings are similar as the normalized discrepancy degree decreases, and thus, the identifying section 223 calculates a similarity degree by subtracting the normalized similarity degree from 1.

In the example illustrated in FIG. 16, a similarity degree between the analysis setting A and the analysis setting B is 0.6, and a similarity degree between the analysis setting A and the analysis setting C is 0.8. In this case, focusing on the analysis setting, the identifying section 223 determines that the analysis setting C having the higher similarity degree is more similar to the analysis setting A.

Note that the discrepancy degree in the case where there is a one-level discrepancy is set to 1, and the discrepancy degree the case where there is a two-level discrepancy is set to 2 in the above description. However, the present embodiment is not limited thereto. The discrepancy degree may be set to be even higher than that in the case where there is a one-level discrepancy, for example, by setting 10 as the discrepancy degree in the case where there is a two-level discrepancy. Further, the analysis setting also includes the intensity of the electromagnetic wave or primary ray emitted from the emitter 71 or an integration time of the spectrum. Therefore, the identifying section 223 may calculate a similarity degree such that the similarity degree increases as a matching degree between intensities of electromagnetic waves or primary rays emitted from the emitter 71 increases. Similarly, the identifying section 223 can calculate a similarity degree such that the similarity degree increases as a matching degree between integration times of the first and second detectors 77A and 77B increases.

Then, the identifying section 223 can calculate similarity degrees for the plurality of analysis records AR held in the analysis history holding section 231 such that the similarity degree increases as a matching degree between analysis settings increase, and identify the analysis record AR having an analysis setting with a high similarity degree as the similar analysis record SAR. The analysis setting indicates what kind of analyte has been used as an object of component analysis. Thus, when similar analysis setting are set by the user, component analysis results thereof are highly likely to be obtained by analyzing similar analytes. Therefore, the similarity degree can be calculated based on not only the similarity degree between component analysis results but also on the similarity degree between objects of the component analysis by calculating the similarity degree based on the analysis setting, and a similarity image can be identified more accurately.

<Identification of Similar Analysis Record SAR Using Image>

In the present embodiment, the similar analysis record SAR can be also identified based on the image P included in the analysis record AR.

The identifying section 223 can calculate a similarity degree between the images P included in the analysis records AR in order to identify the similar analysis record SAR using the image P. In the calculation of the similarity degree between the images P, it is possible to use statistical information on a color distribution and a luminance distribution of the image P, a characteristic point included in the image P, machine learning, and the like.

In a case where the statistical information on the color distribution or the luminance distribution of the image P is used, a similarity degree is calculated based on a distance between color distribution histograms or luminance distribution histograms of one image P and the other image P.

In a case where the characteristic point included in the image P is used, an n-dimensional vector is extracted from the image P as a characteristic amount. Then, a similarity degree between the images P is calculated based on a distribution of the n-dimensional vector extracted from each of the images P. Note that the characteristic point is a point whose distribution does not change even if the image P is rotated or a magnification is changed. In this manner, the identifying section 223 calculates the similarity degree such that the images P, which have similar distributions of the characteristic point on the images, are determined to be similar to each other.

In the case of using machine learning, a model that has learned a plurality of the images P in advance is used to calculate a similarity degree between the images P based on an output of an intermediate layer or an output layer.

Note that the similarity degree based on the image P calculated here is an example of an “image similarity degree” in the present embodiment. Further, the images P include the wide-area image, the pre-irradiation image Pb, the post-irradiation image Pa, and the bird's-eye view image Pf, and the image similarity degree may be calculated using the corresponding types of images. It is also possible to use only some images included in the images P, for example, not using the post-irradiation image Pa in which a shape of foreign matter is likely to change for the calculation of the image similarity degree.

Even in a case where an analyte is estimated to be similar to a past analyte, it is sometimes difficult to identify which component analysis result is similar only using the component analysis result. That is, even if component analysis results themselves are similar, there is a possibility that the component analysis result of an analyte different from the analyte assumed by the user may be identified due to a difference in color or shape. The analysis history holding section 231 holds the analysis record in which the component analysis result and the image are associated with each other. In this manner, the image of the analyte is held in the analysis history holding section 231 in association with the component analysis result, and thus, it is possible to determine whether or not an analyte corresponding to a component analysis result identified by the identifying section 223 is the analyte that is assumed by the user.

<Identification of Similar Analysis Record SAR using Acquisition Condition>

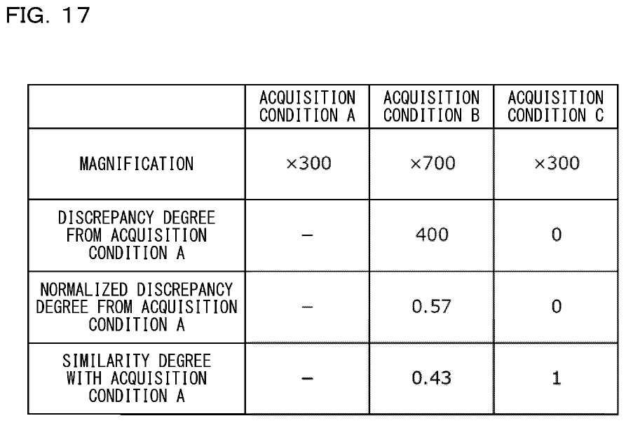

Next, a method in which the identifying section 223 identifies the similar analysis record SAR based on the acquisition conditions included in the analysis record AR will be described with reference to FIG. 17.

As described with reference to FIG. 11, the acquisition conditions include the exposure time, the illumination setting, and the amount of light included in the illumination conditions, the enlargement magnification and the lens type included in the lens information, and the tilt angle θ. A method in which the identifying section 223 identifies the similar analysis record SAR based on the exposure time, the amount of light, the enlargement magnification, and the tilt angle θ, which are quantifiable acquisition conditions among them, will be described first by taking the enlargement magnification as an example.

It is assumed that an acquisition condition A corresponding to the component analysis result A includes information of 300 times as an enlargement magnification, and an acquisition condition B corresponding to the component analysis result B includes information of 700 times as an enlargement magnification, and an acquisition condition C corresponding to the component analysis result C includes information of 300 times as an enlargement magnification. Further, it is assumed that a minimum enlargement magnification of the imaging section is 300 times and a maximum enlargement magnification is 1000 times.

In this case, a difference distance between the acquisition condition A with the enlargement magnification of 300 times and the acquisition condition B with the enlargement magnification of 700 times is 400. A normalized discrepancy degree obtained by dividing this distance of 400 by a normalization constant, which is a difference distance between the maximum enlargement magnification and the minimum enlargement magnification, is 0.57. Since the acquisition conditions are similar as the normalized discrepancy degree decreases, a similarity degree is obtained as 0.43 by subtracting the normalized similarity degree d from 1. Note that a discrepancy degree between the acquisition condition A with the enlargement magnification of 300 times and the acquisition condition C with the enlargement magnification of 300 times is 0, so that a similarity degree is 1.

The method for identifying the similar analysis records SAR based on the quantifiable acquisition conditions will be generalized. The identifying section 223 calculates a difference between numerical values of a reference acquisition condition serving as a comparison reference and a referencing acquisition condition to be compared as a difference distance between the reference acquisition condition and the referencing acquisition condition. Then, the identifying section 223 calculates a normalized distance obtained by dividing the difference distance by a normalization constant which is a difference between a maximum value and a minimum value of the acquisition conditions. Then, a value, obtained by subtracting the normalized distance from 1, is calculated as a similarity degree such that the similarity degree increases as the normalized distance decreases. That is, the identifying section 223 calculates the similarity degree such that the similarity degree increases as a matching degree between the acquisition conditions increases.

Next, a description will be given regarding a method in which the identifying section 223 identifies the similar analysis record SAR based on the illumination setting and the lens type which are acquisition conditions that are not expressed in numerical values. In this case, if acquisition conditions match between the reference acquisition condition and the referencing acquisition condition, a similarity degree is set to 1. If not, the similarity degree is set to 0. That is, a matching degree between the acquisition conditions can be expressed by binary data of 0 and 1. Even in this case, the identifying section 223 calculates the similarity degree such that the similarity degree increases as the matching degree between the acquisition conditions increases.

Note that, in a case where a similarity degree is calculated using a plurality of pieces of information included in one acquisition condition, similarity degrees may be calculated respectively for the pieces of information, and a sum of the calculated similarity degrees may be used as the similarity degree of the acquisition condition. That is, when one acquisition condition includes an enlargement magnification and the amount of light, a sum of a similarity degree calculated for the enlargement magnification and a similarity degree calculated for the amount of light is a similarity degree corresponding to the one acquisition condition.

Then, the identifying section 223 can calculate the similarity degrees of the plurality of analysis records AR held in the analysis history holding section 231, and identify the analysis record AR having the acquisition condition with the high similarity degree as the similar analysis record SAR.

The identification of the similar analysis record SAR in consideration of the acquisition condition can be used in a case where images themselves are similar, but enlargement magnifications or at the time of capturing an analyte are different or exposure times are different. In such a case, it is difficult to identify a similar image more accurately only by a similarity degree between the images themselves. Therefore, the similar image can be identified based on both of the similarity degree of the image itself and the similarity degree of the acquisition condition at the time of acquiring the image by calculating the image similarity degree such that a similarity degree of an image acquired under the same acquisition condition is higher. Thus, the similar images can be identified more accurately.

<Calculation of Overall Similarity Degree>

The identifying section 223 can consider each of the analysis similarity degree, which is the similarity degree calculated based on the component analysis result, the similarity degree calculated based on the analysis setting, the similarity degree calculated based on the acquisition condition, and the image similarity degree, which is the similarity degree calculated based on the image P, in order to identify the similar analysis record SAR similar to one analysis record AR. That is, the identifying section 223 can calculate the plurality of similarity degrees including the analysis similarity degree and the image similarity degree in order to identify the similar analysis record SAR, and can calculate an overall similarity degree by integrating the similarity degrees. Note that the analysis record AR including the component analysis result A, the analysis setting A associated with the component analysis result A as a master key, and the acquisition condition A is assumed to be ARa. Similarly, the analysis record AR including the component analysis result B, the analysis setting B associated with the component analysis result B as a master key, and the acquisition condition B is assumed to be ARb, and analysis record AR including the component analysis result C, the analysis setting C associated with the component analysis result C as a master key, and the acquisition condition C is assumed to be ARc.

When the three similarity degrees based on the component analysis result, the analysis setting, and the magnification as the acquisition condition are calculated by the identifying section 223, an overall similarity degree between the analysis record ARa and the analysis record ARb is 0.56 which is an average of the three similarity degrees based on the component analysis result, the analysis setting, and the magnification as the acquisition condition. Similarly, an overall similarity degree between the analysis record ARa and the analysis record ARc is 0.75. In this case, the identifying section 223 identifies the analysis record ARc as the similar analysis record SAR of the analysis record ARa since the analysis record ARc has the higher similarity degree than the analysis record ARb.

Note that the identifying section 223 can also identify a plurality of the similar analysis records SAR based on the overall similarity degree. That is, the identifying section 223 calculates similarity degrees respectively for the plurality of analysis records AR held in the analysis history holding section 231. Then, the identifying section 223 calculates an overall similarity degree based on the calculated similarity degrees. Here, the overall similarity degree may be a sum or a product of one similarity degree and another similarity degree, or may be calculated by weighting a specific similarity degree. Then, the identifying section 223 can identify the plurality of similar analysis records SAR from among the plurality of analysis records AR held in the analysis history holding section 231 based on the magnitude of the overall similarity degree. In this manner, the similar analysis record SAR is identified based on not only the component analysis result but also the similarity degrees of the image, the analysis setting, and the like, so that the similar analysis record can be identified more accurately.

<Case Where Similar Analysis Record SAR Does Not Exist>

In the above description, the method in which the identifying section 223 identifies the plurality of similar analysis records SAR based on the similarity degree has been described. A predetermined threshold may be set for the similarity degree in order to identify the similar analysis record SAR. In this case, when the analysis record AR equal to or higher than the threshold exists, the identifying section 223 identifies this analysis record AR as the similar analysis record SAR. Further, if the analysis record AR equal to or higher than the threshold does not exist, the identifying section 223 identifies that the similar analysis record SAR does not exist in the analysis history holding section 231, and that the display controller 221a is controlled such that a “newly analyzed sample” is displayed on the display 22.

That is, the identifying section 223 in the present embodiment identifies the similar analysis record SAR from the analysis history holding section 231 in which results of component analysis performed in the past have been accumulated. Therefore, when the user performs component analysis of a completely new sample SP, there is a case where the similar analysis record SAR corresponding to the sample SP does not exist. In such a case, it is notified that the sample is a “newly analyzed sample”, so that the user can more accurately evaluate the similarity degree of the component analysis result.

<Search Setting Screen>

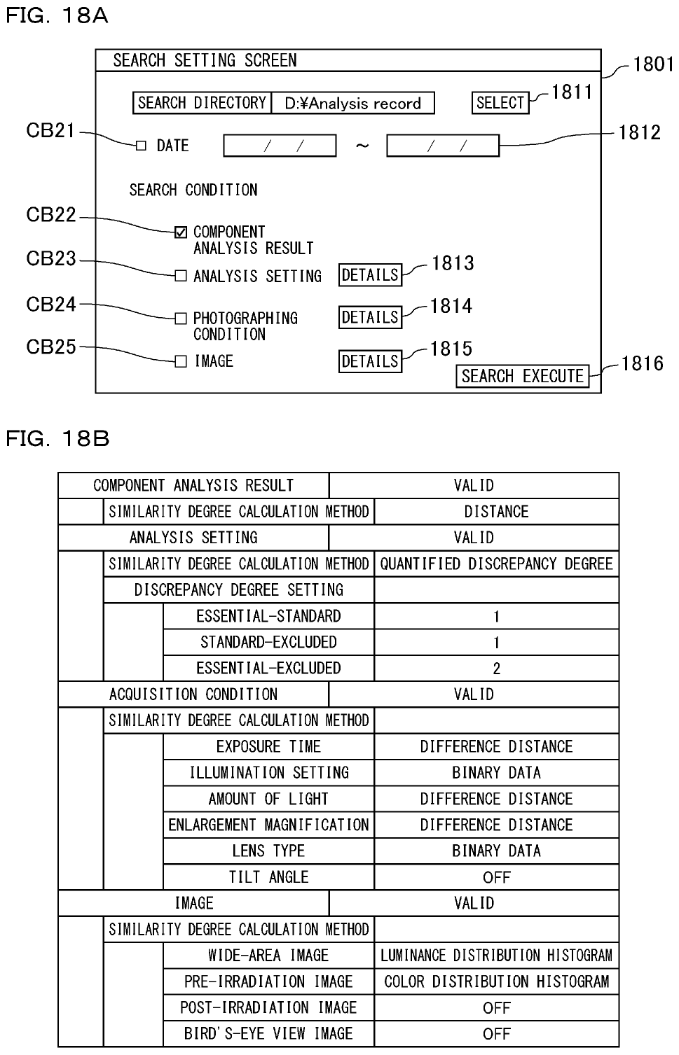

FIG. 18A is a view illustrating an example of a search setting screen configured to identify the similar analysis record SAR. The display controller 221a can display a search setting screen 1801 on the display 22. Further, a similarity search setting section 226c receives a similarity search setting via the input receiver 221b. In the similarity search setting set here, setting data is held according to a setting table illustrated in FIG. 18B.

The search setting screen 1801 includes a search directory selection button 1811, a check box CB21 for selecting whether or not to designate a search target period, a date input field 1812 for designating the search target period, a check box CB22 for selecting whether or not to use the component analysis result to identify the similar analysis record SAR, a check box CB23 for selecting whether or not to use the analysis setting to identify the similar analysis record SAR, a detailed setting button 1813 for setting a search condition related to the analysis setting in detail, a check box CB24 for selecting whether or not to use the acquisition condition to identify the similar analysis record SAR, a detailed setting button 1814 for setting a search condition related to the acquisition condition in detail, a check box CB25 for selecting whether or not to use the image to identify the similar analysis record SAR, a detailed setting button 1815 for setting a search condition related to the image in detail, and a search execution button 1816 for starting a search for the similar analysis record SAR.

The search directory selection button 1811 is a button for selecting a directory of the analysis history holding section 231 in order to identify a similar analysis record. Here, “D: Analysis record” is selected as the directory of the analysis history holding section 231.

The check box CB21 is a check box for selecting whether or not to designate the search target period. When the input receiver detects the selection of the check box CB21, the similarity search setting section 226c sets a period input in the date input field 1812 as the search target period.

The check box CB22 is a check box for selecting whether or not to use the component analysis result to identify the similar analysis record SAR. When the input receiver 221b detects the selection of the check box CB22, the similarity search setting section 226c adds the component analysis result as a similarity degree calculation target. That is, the component analysis result is set to “valid” on the setting table.

The check box CB23 is a check box for selecting whether or not to use the analysis setting to identify the similar analysis record SAR. When the input receiver 221b detects the selection of the check box CB23, the similarity search setting section 226c adds the analysis setting as a similarity degree calculation target. That is, the analysis setting is set to “valid” on the setting table. Further, when the display controller 221a detects that the detailed setting button 1813 has been pressed, the display controller 221a can cause the display 22 to display an editing screen to edit weightings of the discrepancy degrees of the standard item, the essential item, and the excluded item, which are the classes set for each element. The weighting of the discrepancy degree set here is stored in the setting table as a discrepancy degree setting.

The check box CB24 is a check box for selecting whether or not to use the acquisition condition to identify the similar analysis record SAR. When the input receiver 221b detects the selection of the check box CB24, the similarity search setting section 226c adds the acquisition condition as a similarity degree calculation target. That is, the acquisition condition is set to “valid” on the setting table. Further, when detecting that the detailed setting button 1814 has been pressed, the display controller 221a can cause the display 22 to display a selection screen to select which information is to be used to calculate the similarity degree among the plurality of pieces of information such as the exposure time and the enlargement magnification included in the acquisition conditions. For the information selected as a similarity degree calculation target, a similarity degree calculation method per information is stored in the setting table. In the example illustrated in FIG. 18B, the exposure time, the illumination setting, the amount of light, the enlargement magnification, and the lens type are selected as the similarity degree calculation targets. Further, the storage in the setting table can be performed such that the difference distance is used as the similarity degree calculation method for the exposure time, the amount of light, and the enlargement magnification, and the binary data is used as the similarity degree calculation method for the illumination setting and the lens type.

The check box CB25 is a check box for selecting whether or not to use the image to identify the similar analysis record SAR. When the input receiver 221b detects the selection of the check box CB25, the similarity search setting section 226c adds the image as a similarity degree calculation target. That is, the image is set to “valid” on the setting table. Further, when the display controller 221a detects that the detailed setting button 1814 has been pressed, the display controller 221a can cause the display 22 to display an editing screen to select which image P is to be used for the similarity degree calculation among the wide-area image, the pre-irradiation image Pb, the post-irradiation image Pa, and the bird's-eye view image Pf and to adjust various parameters for the comparison of the image P. For the image selected as a similarity degree calculation target, a similarity degree calculation method per image is stored in the setting table. In the example illustrated in FIG. 18B, the wide-area image and the pre-irradiation image Pb are selected as the similarity degree calculation targets. Further, the storage in the setting table can be performed such that the luminance distribution histogram and the color distribution histogram are used as the similarity degree calculation methods for the wide-area image and the pre-irradiation image Pb, respectively. In these search settings, any degree of weighting may be adjustable in order for more detailed settings, instead of the simple selection between the use and non-use.

<Similarity Degree Calculation Flow>

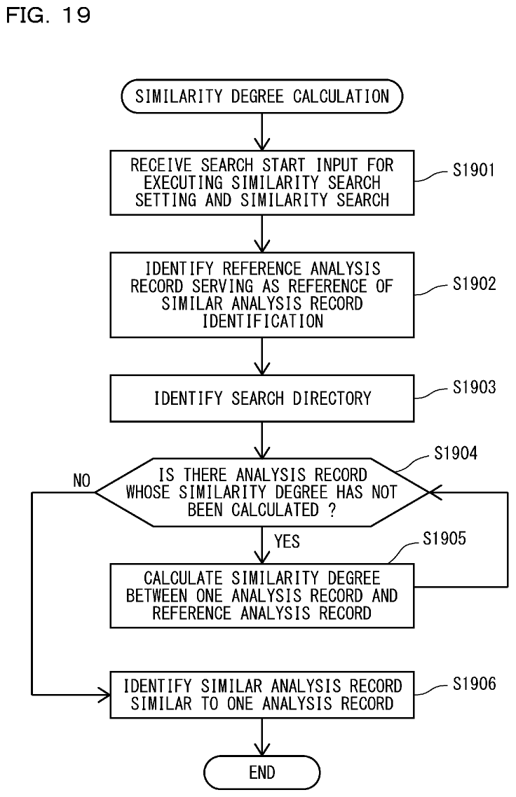

FIG. 19 is a flowchart for describing a procedure in which the identifying section 223 calculates the similarity degree.

First, in step S1901, the similarity search setting section 226c receives a similarity search setting set on a search setting screen 2901 and a search start input for executing a similarity search. The search start input for executing the similarity search can be executed, for example, by the input receiver 221b determining whether or not the search execution button 1816 illustrated in FIG. 18A has been pressed.

Next, in step S1902, the identifying section 223 identifies a reference analysis record that serves as a reference at the time of identifying the similar analysis record SAR. As the reference analysis record, for example, it is possible to use the analysis record AR including a component analysis result displayed on the display 22 after component analysis is performed by the component analysis section 216. Note that the reference analysis record does not necessarily include the image P corresponding to the component analysis result. That is, the display controller 221a causes the display 22 to display the component analysis result obtained by the component analysis section 216. Then, the identifying section 223 may use the component analysis result displayed on the display 22 as the reference analysis record. Further, as the reference analysis record, it is also possible to use one analysis record AR selected from the analysis history holding section 231 by the user operating the operation section 3. In this case, the input receiver 221b receives the selection of the one analysis record AR selected by the user operating the operation section 3, and sets this analysis record AR as the reference analysis record.

Next, in step S1903, the identifying section 223 identifies a search directory set in the similarity search setting section 226c.

Subsequently, in step S1904, whether or not similarity degree calculation has been completed is determined for each of a plurality of the analysis records AR existing in the search directory identified in step S1903. That is, in step S1904, it is determined whether or not the analysis record AR whose similarity degree has not been calculated exists in the search directory identified in step S1903. The process proceeds to step S1905 if the determination is YES, and proceeds to step S1906 if the determination is NO.

In step S1905, the identifying section 223 calculates the similarity degree with the reference analysis record for one analysis record AR which exists in the search directory identified in step S1903 and of which the similarity degree has not been calculated. This similarity degree calculation is performed based on the similarity search setting set in step S1901. That is, the similarity degree is calculated according to the setting table illustrated in FIG. 18B. Specifically, the identifying section 223 determines whether or not the component analysis result is valid as the similarity degree calculation target based on the setting table. If the determination is YES, the identifying section 223 identifies a similarity degree calculation method from the setting table and calculates an analysis similarity degree according to the identified similarity degree calculation method. Next, the identifying section 223 determines whether or not the analysis setting is valid as the similarity degree calculation target based on the setting table. If the determination is YES, the identifying section 223 identifies a similarity degree calculation method and a discrepancy degree setting from the setting table, and calculates a similarity degree based on the identified similarity degree calculation method and the discrepancy degree setting. Similarly, the identifying section 223 determines whether or not the acquisition condition and the image P are valid as the similarity degree calculation targets and acquires similarity degree calculation methods based on the setting table.

When the processing of step S1905 is completed, returning to S1904, whether or not the similarity degree calculation has been completed is determined for each of the plurality of analysis records AR existing in the search directory identified in step S1903.

Then, in step S1906, the similar analysis record SAR similar to the reference analysis record is identified based on the similarity degree calculated in step S1905. Step S1906 is an example of an “identification step” in the present embodiment.

5. Similarity Search Result Display Screen 1000

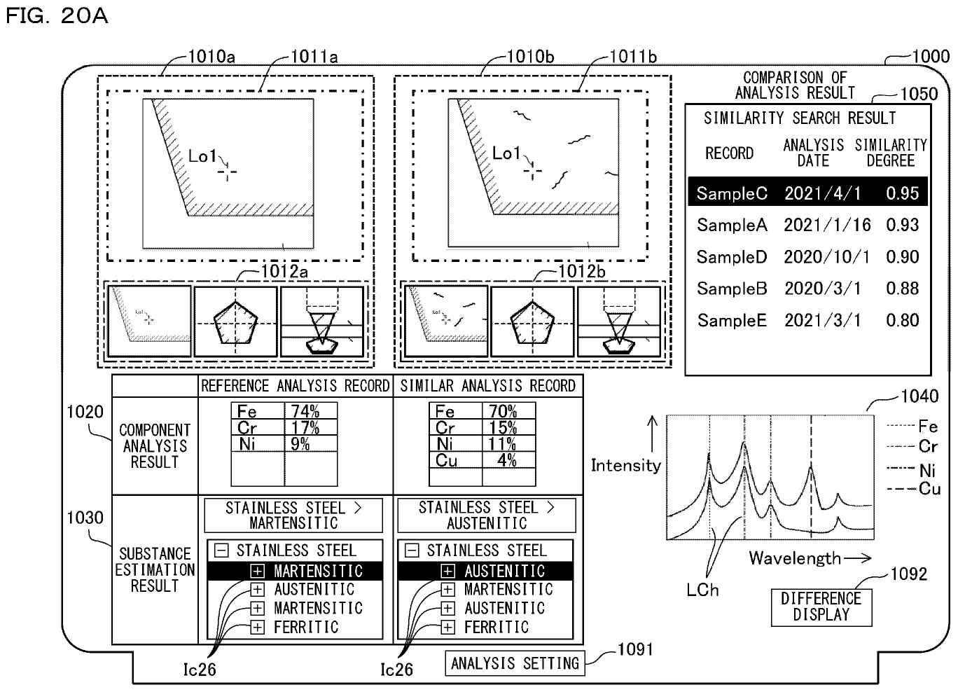

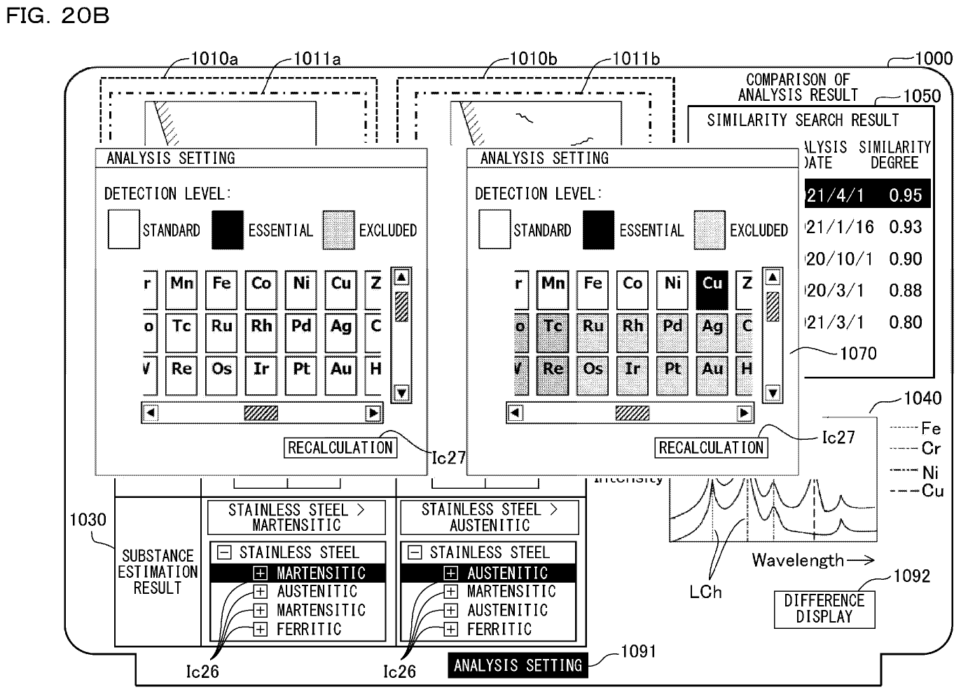

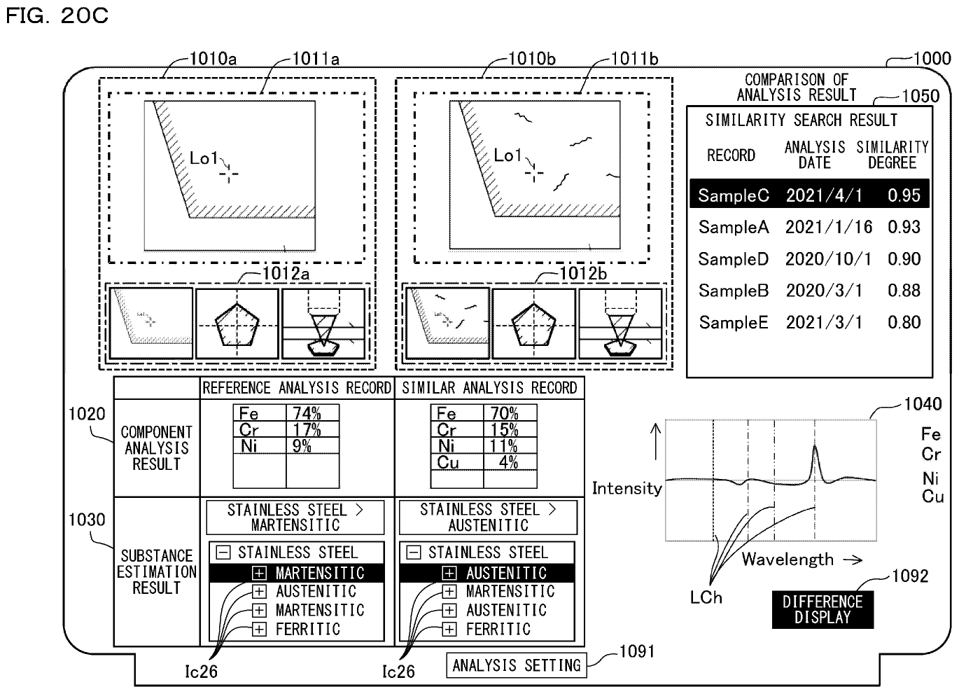

FIG. 20A is a view illustrating an example of a similarity search result display screen 1000 that displays the similar analysis record SAR identified by the identifying section 223. Since the similarity search result display screen 1000 is displayed on the display 22, a “display step” can be executed. The similarity search result display screen 1000 includes a reference image display area 1010a, a similar image display area 1010b, a component analysis result display area 1020, a substance estimation result display area 1030, a spectrum display area 1040, a similarity search result display area 1050, an analysis setting button 1091, and a difference display button 1092.

—Reference Image Display Area 1010a—

The reference image display area 1010a illustrated in FIG. 20A includes a main display area 1011a and sub-display areas 1012a. The main display area 1011a is an area configured to display the image P included in the reference analysis record. There is a case where the reference analysis record is associated with the plurality of images P, such as the wide-area image, the pre-irradiation image Pb, the post-irradiation image Pa, and the bird's-eye view image Pf. In that case, the display controller 221a can cause the display 22 to display the sub-display area 1012a which has a relatively smaller display size than the main display area 1011a. Then, the display controller 221a can cause the display 22 to display the main display area 1011a assigned with the pre-irradiation image Pb captured by the first camera 81. Further, the display controller 221a can cause the display 22 to display the sub-display area 1012a assigned with the post-irradiation image Pa, the bird's-eye view image Pf, or the wide-area image captured by the first camera 81. That is, the reference image display area 1010a may cause the display 22 to display the main display area 1011a to which the pre-irradiation image Pb and the post-irradiation image Pa, which are the images P obtained by capturing the sample SP at a high magnification by the first camera 81, can be assigned and the sub-display areas 1012a to which the wide-area image, the bird's-eye view image Pf, the pre-irradiation image Pb, and the post-irradiation image Pa of the sample SP, which are images included in the reference analysis record, can be assigned in a divided manner. Note that the input receiver 221b may receive the selection of one image P from among the images P displayed in the sub-display area 1012a, and the display controller 221a may display the selected image in the main display area 1011a.

—Similar Image Display Area 1010b—

The similar image display area 1010b illustrated in FIG. 20A includes a main display area 1011b and sub-display areas 1012b. The reference image display area 1010b may cause the display 22 to display the main display area 1011b to which the pre-irradiation image Pb and the post-irradiation image Pa, which are the images P obtained by capturing the sample SP at a high magnification by the first camera 81, can be assigned and the sub-display areas 1012b to which the wide-area image, the bird's-eye view image Pf, the pre-irradiation image Pb, and the post-irradiation image Pa of the sample SP, which are images included in the similar analysis record, can be assigned in a divided manner, which is similar to the reference image display area 1010a. Note that the input receiver 221b may receive the selection of one image P from among the images P displayed in the sub-display area 1012a, and the display controller 221a may display the selected image in the main display area 1011a.

Note that, when a plurality of the similar analysis records SAR have been identified by the identifying section 223, the input receiver 221b receives the selection of one similar analysis record SAR through the operation of the operation section 3 performed by the user. Then, the display controller 221a can display the image P included in the selected one similar analysis record in the similar image display area 1010b.

As described above, each of the reference image display area 1010a and the similar image display area 1010b is displayed on the display 22 to be divided into each of the main display areas 1011a and 1011b to which the pre-irradiation image Pb can be assigned as the image P, and each of the sub-display areas 1012a and 1012b to which the wide-area image and the bird's-eye view image Pf can be assigned as the image P. Note that each of the main display areas 1011a and 1011b has a larger display size on the display 22 than each of the sub-display areas 1012a and 1012b, so that it is possible to easily confirm an appearance of the sample SP as the analyte. Further, each of the sub-display areas 1012a and 1012b has a smaller display size on the display 22 than each of the main display areas 1011a and 1011b, so that the pre-irradiation image Pb of the sample SP can be first confirmed, and the image P related to the pre-irradiation image Pb can also be referred to.

—Component Analysis Result Display Area 1020—

The component analysis result display area 1020 illustrated in FIG. 20A is an area that displays the characteristic estimated by the characteristic estimator 216a based on the spectra included in the reference analysis record and the similar analysis record SAR. The component analysis result, which is the characteristic Ch included in the reference analysis record, and the characteristic Ch included in the similar analysis record SAR are displayed in the component analysis result display area 1020. In the example illustrated in FIG. 20A, constituent elements of the sample SP and contents thereof are displayed as the characteristic Ch. Note that, when the component analysis of the sample SP is performed using the analysis method such as the IR method, a molecular structure constituting the sample SP may be displayed as the characteristic Ch. That is, the component analysis section 216 can extract the molecular structure constituting the sample SP as the characteristic of the sample SP. In this case, the presence or absence of a functional group, such as O—H and N—H, may be displayed in the component analysis result display area 1020 instead of the constituent elements and the contents thereof.

—Substance Estimation Result Display Area 1030—

The substance estimation result display area 1030 illustrated in FIG. 20A is an area that displays information for identifying the substance estimated by the substance estimator 216b based on the component analysis results included in the reference analysis record and the similar analysis record SAR. Here, examples of the information for identifying the substance include the superclass, the intermediate class, and the like of the substance. That is, a common name, a general term, and the like of the substance estimated by the substance estimator 216b are included. That is, when the substance estimator 216b estimates that the substance is the SUS300 series, information such as austenitic stainless steel, stainless steel, and alloy corresponds to the information for identifying the substance. The substance estimator 216b can estimate a plurality of characteristics included in the sample SP with a relatively high accuracy from the subclasses C3. Further, the display controller 221a can cause the display 22 to display the intermediate class C2 or the superclass C1 to which the characteristics estimated from the subclasses C3 by the substance estimator 216b belong. In the example illustrated in the substance estimation result display area 1030 corresponding to the reference analysis record of FIG. 20A, it is illustrated that the substance estimator 216b has estimated characteristics who belong to “martensitic”, which is the intermediate class C2, as the subclasses C3 of the characteristics that can be included in the sample SP at the highest accuracy. Furthermore, it is illustrated that the substance estimator 216b has estimated characteristics belonging to “austenitic” as the intermediate class C2 of the characteristics with the next highest accuracy. In a case where the intermediate classes C2 or the superclasses C1 are displayed in the order of the accuracy of the subclass C3 estimated by the substance estimator 216b, the substance estimation result display area 1030 sometimes display the same intermediate class C2 or superclass C1 a plurality of times. In this case, the display controller 221a can display the hidden subclass C3 when the input receiver 221b receives the pressing of an open/close icon IC26 corresponding to the intermediate class C2 or the superclass C1. As a result, the user who desires to identify a characteristic in more detail can also grasp the characteristic included in the sample SP. Note that classes, such as chain hydrocarbon, cyclic hydrocarbon, alcohol, ether, and aromatic, may be displayed when the component analysis of the sample SP is performed using the analysis method such as the IR method.

—Spectrum Display Area 1040—

The spectrum display area 1040 illustrated in FIG. 20A is an area that displays the spectra included in the reference analysis record and the similar analysis record SAR. The display controller 221a can also display each of the spectrum included in the reference analysis record and the spectrum included in the similar analysis record SAR individually on the display 22. Further, the spectrum included in the reference analysis record and the spectrum included in the similar analysis record SAR can be superimposed and displayed on the same graph as illustrated in FIG. 20A. In this case, it is suitable for the user to grasp whether or not there is a difference between the spectrum included in the reference analysis record and the spectrum included in the similar analysis record SAR.

Further, the display controller 221a can display a characteristic line LCh at a position on the spectrum corresponding to the characteristic estimated by the characteristic estimator 216a. The characteristic line LCh is an auxiliary line to be displayed at a position corresponding to a peak position of the estimated characteristic Ch. As a result, the user can grasp any position peak on the spectrum that has been used as a base of the estimation of the characteristic Ch of the sample SP.

—Similarity Search Result Display Area 1050—

The similarity search result display area 1050 illustrated in FIG. 20A is an area that displays the similar analysis record SAR identified by the identifying section 223. The display controller 221a can display a plurality of the similar analysis records SAR identified by the identifying section 223 in the similarity search result display area 1050 based on the magnitude of the similarity degree. In the example illustrated in FIG. 20A, as an example, a record name of the similar analysis record SAR, an analysis date which is the date when the similar analysis record SAR has been acquired, and a similarity degree are displayed in a list in descending order of the similarity degree. Although not illustrated, a thumbnail of one image included in the similar analysis record may be displayed in addition to the record name and the like. Further, “Sample C” expressed by white letters on a black background indicates that it has been selected as the similar analysis record SAR to be displayed on the display 22 by the input receiver 221b. In this case, the image P, a component analysis result, a substance estimation result, and a spectrum included in “Sample C”, which is one similar analysis record SAR selected by the input receiver 221b, are displayed on the display 22.

Further, the input receiver 221b can receive the switching selection of the similar analysis record SAR to be displayed on the display 22. When detecting that one similar analysis record SAR selected by the input receiver 221b has been switched, the display controller 221a causes the display 22 to display the image P, a component analysis result, a substance estimation result, and a spectrum included in the similar analysis record SAR after switching instead of the image P, a component analysis result, a substance estimation result, and a spectrum included in the similar analysis record SAR before switching. That is, the display controller 221a updates the image P displayed in the similar image display area 1010b to the image P included in the similar analysis record SAR selected after switching in response to the switching of the similar analysis record SAR. On the other hand, the display controller 221a does not change the image P displayed in the reference image display area 1010a even if the similar analysis record SAR is switched. In this manner, the image P displayed in the similar image display area 1010b is updated while holding the image P displayed in the reference image display area 1010a, so that the user can use which image P is similar to the image P included in the reference analysis record serving as the comparison reference.

The display controller 221a can update and display the content to be displayed in each of the component analysis result display area 1020, the substance estimation result display area 1030, and the spectrum display area 1040 to a component analysis result, a substance estimation result, and a spectrum included in one similar analysis record SAR whose selection has been received by the input receiver 221b in response to the switching of the similar analysis record SAR in the same manner as in the similar image display area 1010b.

There is a case where the analysis record AR identified by the identifying section 223 as being most similar to one component analysis result is not always what the user wants. Even in such a case, since the plurality of similar analysis records each having a high similarity degree are displayed in the list format, the user can easily identify a desired similar analysis record.

—Analysis Setting Button 1091—

The analysis setting button 1091 illustrated in FIG. 20A is a button configured to display the analysis setting screen 1070 for confirming and editing the analysis setting set by the analysis setting section 226a.

When the operation of the analysis setting button 1091 is detected by the input receiver 221b, the display controller 221a sets the analysis setting included in the reference analysis record and the analysis setting included in the similar analysis record SAR on the display 22.

FIG. 20B is a view illustrating a case where the analysis setting button 1091 is operated on the similarity search result display screen 1000 illustrated in FIG. 20A. The analysis setting included in the reference analysis record and the analysis setting included in the similar analysis record SAR are superimposed and displayed on the similarity search result display screen 1000. In FIG. 20B, all elements displayed on the display 22 are classified as the standard items in the example illustrated as the analysis setting corresponding to the reference analysis record. Further, in the example illustrated as the analysis setting corresponding to the similar analysis record SAR in FIG. 20B, Cu is classified as the essential item and the others are classified as the standard items among elements belonging to the fourth period displayed on the display 22. Further, all elements belonging to the fifth cycle and the sixth cycle displayed on the display 22 are classified as the excluded items.

The input receiver 221b receives the user's editing of the analysis setting on the analysis setting screen 1070. Then, when the input receiver 221b receives the operation of an icon Ic27 notated as recalculation, the characteristic estimator 216a acquires an analysis setting at a timing when the icon Ic27 has been operated, and executes recalculation of the characteristic Ch based on the acquired analysis setting and the spectrum.

Since the analysis settings as the analysis conditions of the component analysis result are displayed on the display 22, the user can easily grasp whether or not a reason why the component analysis results are different is due to a difference in the analysis settings. If the different component analysis results are obtained due to the difference in the analysis settings, an element that is considered to be essentially contained in the sample SP can be classified as the essential item, and an element that is not considered to be contained in the sample SP can be classified as the excluded item. As a result, even if the same elements are detected as different elements due to a slight difference in spectrum, there is a high possibility that a correct component analysis result can be obtained. Pursuing the reason for the difference in the component analysis results is burden for a user who is not familiar with the component analysis. Since not only the component analysis result itself but also the analysis setting as the acquisition condition of the component analysis result is displayed, it is possible to achieve both the improvement in precision of the component analysis and the improvement in usability.

—Difference Display Button 1092—

The difference display button 1092 illustrated in FIG. 20A is a button configured to display a difference spectrum representing a difference between the spectrum included in the reference analysis record and the spectrum included in the similar analysis record SAR.

When the operation of the difference display button 1092 is detected by the input receiver 221b, the display controller 221a displays the difference spectrum on the spectrum display area 1040 of the display 22. The difference spectrum may be generated by the processor 21a in response to the operation of the difference display button 1092. The difference spectrum is generated by calculating a difference between an intensity value of one spectrum and an intensity value of the other spectrum at each wavelength.

Further, the display controller 221a can display the characteristic line LCh at a position on the difference spectrum corresponding to the characteristic Ch estimated by the characteristic estimator 216a. As an example, when three peaks of Fe, Cr, and Ni are detected in the spectrum included in the reference analysis record, Fe, peak positions of Fe, Cr, and Ni can be displayed to be distinguishable on the difference spectrum by displaying the characteristic lines LCh of Fe, Cr, and Ni on the difference spectrum. That is, the display controller 221a can display the peak position of the spectrum associated with the component analysis result included in the reference analysis record on the difference spectrum.

Further, when a peak that does not exist in the spectrum included in the reference analysis record exists in the spectrum included in the similar analysis record SAR, the display controller 221a may display a position of the peak existing in the spectrum included in the similar analysis record SAR to be distinguishable on the difference spectrum. That is, when a peak of Cu has been detected in the spectrum included in the similar analysis record SAR as illustrated in FIG. 20C, the characteristic line LCh of Cu may be displayed on the difference spectrum in addition to the characteristic lines LCh of Fe, Cr, and Ni.

That is, the display controller 221a can display the difference spectrum representing the difference between the spectrum included in the reference analysis record and the spectrum included in the similar analysis record on the display 22. Furthermore, the display controller 221a can display the characteristic lines LCh corresponding to the peak position of the spectrum included in the reference analysis record and the peak position of the spectrum included in the similar analysis record on the difference spectrum. As a result, it is possible to display the peak positions on the difference spectrum in a distinguishable manner.

The difference spectrum represents a difference between intensity values at each wavelength of the spectrum for each wavelength. As an intensity value of the difference spectrum at a certain wavelength is closer to zero, intensity values of the spectrum at that wavelength are similar. As an intensity value of the difference spectrum at a certain wavelength is farther from zero, a discrepancy between intensity values of the spectrum at that wavelength increases. That is, a case where there is no peak on the difference spectrum indicates that the spectra are similar to each other, and a case where there is a peak on the difference spectrum indicates that there is a difference between the spectra at a wavelength corresponding to the peak.

Since there are a plurality of peaks in the spectra, it is difficult for the user to determine the similarity degree between the spectra only by comparing the spectra. However, the user can intuitively determine whether or not the spectra are similar to each other by confirming the difference spectrum.

Furthermore, it is possible to display a peak position of the spectrum associated with one component analysis result on the difference spectrum in a distinguishable manner according to this configuration. Therefore, when a peak exists in the difference spectrum, it is possible to grasp to which peak position in the spectrum the peak corresponds.

Since the display controller 221a causes the display 22 to display the difference spectrum in this manner, it is possible to intuitively grasp at which position the difference between the spectrum included in the reference analysis record and the spectrum included in the similar analysis record SAR occurs. Furthermore, since the characteristic line LCh is displayed on the difference spectrum to make the peak position distinguishable, it is possible to grasp to which element the above difference corresponds. As a result, even if the user is not familiar with the analysis, a factor that causes the difference in the component analysis result can be easily evaluated, which can contribute to the improvement in usability.

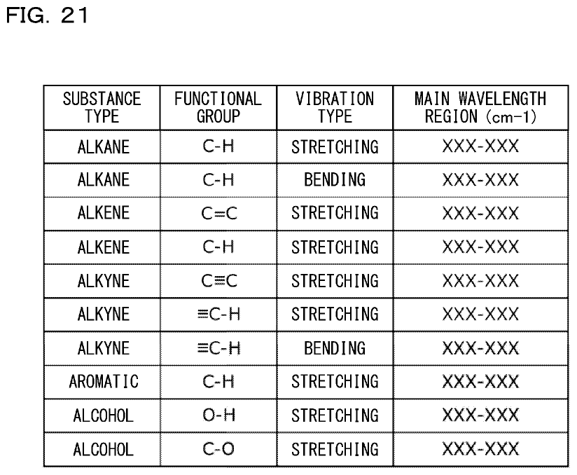

Although the case where the characteristic estimator 216a estimates a constituent element of the sample SP and a content of the constituent element as a characteristic from a spectrum, as the characteristic Ch, has been mainly described in the above description, the present embodiment is limited thereto. For example, a type of a functional group constituting an organic substance and a type of vibration of the functional group may be estimated as the characteristic Ch from the spectrum. In this case, as illustrated in FIG. 21, a C—H stretching vibration, a C—H bending vibration, and the like are extracted as the characteristics Ch corresponding to peak positions on the spectrum. Further, as the substance library LiS, what is obtained by associating one characteristic with ab absorption wavelength included in the one characteristic can be used.

In this manner, the present invention can be applied to component analysis of the sample SP performed using a spectrum, and can be widely used for component analysis of inorganic substances and organic substances.

As described above, the analysis device according to the present invention can be used for component analysis of various samples.

What is claimed is:

1. An analysis device that performs component analysis of an analyte, the analysis device comprising:
a placement stage on which an analyte is placed;
an emitter which emits an electromagnetic wave or an electron beam to the analyte placed on the placement stage;
a spectrum acquirer which acquires a spectrum obtained from the analyte irradiated with the electromagnetic wave or electron beam emitted from the emitter;
a component analysis section which performs component analysis of the analyte based on the spectrum acquired by the spectrum acquirer;
an analysis history holding section which holds a plurality of component analysis results obtained by the component analysis section as an analysis history;
an identifying section which identifies a component analysis result similar to one component analysis result obtained by the component analysis section among the plurality of component analysis results held in the analysis history holding section; and
a display controller which causes a display to display the component analysis result identified by the identifying section.

2. The analysis device according to claim 1, further comprising:
a first camera which receives reflection light reflected by the analyte placed on the placement stage;
an imaging processor which generates images of the analyte based on the reflection light received by the first camera; and
an input receiver which receives a search start input for performing the identification of the component analysis result by the identifying section,
wherein the analysis history holding section holds, as the analysis history, a plurality of analysis records in which the component analysis results obtained by the component analysis section are associated with the images generated by the imaging processor when the component analysis results are acquired, respectively,
the identifying section identifies an analysis record having a component analysis result similar to the one component analysis result obtained by the component analysis section as a similar analysis record from among the plurality of analysis records held in the analysis history holding section in response to reception of the search start input by the input receiver, and
the display controller causes the display to display the component analysis result included in the similar analysis record identified by the identifying section and the image associated with the component analysis result.

3. The analysis device according to claim 2, wherein
the identifying section calculates a similarity degree between the one component analysis result and the component analysis result included in each of the analysis records for the plurality of analysis records held in the analysis history holding section, and identifies a plurality of the similar analysis records based on the similarity degree, and
the display controller causes the display to display a list of the images respectively included in the plurality of similar analysis records.

4. The analysis device according to claim 3, wherein
the input receiver receives selection of one similar analysis record from among the plurality of similar analysis records displayed in a list on the display, and
the display controller switches a component analysis result and the image associated with the component analysis result to be displayed on the display to a component analysis result of the one similar analysis record selected by the input receiver and the image associated with the component analysis result.

5. The analysis device according to claim 2, wherein
the input receiver receives selection of an analysis record having the one component analysis result from among the plurality of analysis records held in the analysis history holding section,
the identifying section identifies a similar analysis record similar to the analysis record having the one component analysis result selected by the input receiver from among the plurality of analysis records held in the analysis history holding section, and
the display controller causes the display to display the one component analysis result and a component analysis result included in the similar analysis record identified by the identifying section.

6. The analysis device according to claim 4, wherein
the display controller causes the display to display:
a reference image display area to which an image, generated by the imaging processor based on reflection light received by the first camera when the one component analysis result is acquired, is assigned; and
a similar image display area to which the image included in the one similar analysis record is assigned, and
updates an image to be displayed in the similar image display area to an image included in the similar analysis record selected by the input receiver.

7. The analysis device according to claim 6, further comprising
a second camera which has a wider visual field range than the first camera,
wherein the imaging processor generates wide-area images of the analyte based on reflection light received by the second camera,
the analysis history holding section holds, as the analysis record, the wide-area image generated based on the reflection light received by the second camera and the component analysis result in association with each other,
the identifying section identifies an analysis record having a component analysis result similar to the one component analysis result obtained by the component analysis section as a similar analysis record from among the plurality of analysis records held in the analysis history holding section, and
the display controller causes the display to display the component analysis result and the wide-area image included in the similar analysis record identified by the identifying section.

8. The analysis device according to claim 7, wherein
the display controller causes the display to display the similar image display area to be divided into a main display area and sub-display areas each of which is set to have a smaller display size on the display than a display size of the main display area and displays images included in the similar analysis record, and, in response to the input receiver receiving selection of one image from among the images displayed in the sub-display area, displays the selected image in the main display area.

9. The analysis device according to claim 3, wherein
the identifying section calculates an analysis similarity degree, which is the similarity degree between the one component analysis result and the component analysis result included in the analysis record, and an image similarity degree, which is a similarity degree between the image associated with the one component analysis result and the image included in the analysis record, for the plurality of analysis records held in the analysis history holding section, and
identifies a plurality of the similar analysis records based on the analysis similarity degree and the image similarity degree.

10. The analysis device according to claim 9, wherein
the analysis history holding section holds, as the analysis record, an acquisition condition of the image generated based on the reflection light received by the first camera and the component analysis result in association with each other, and
the identifying section calculates the image similarity degree based on an acquisition condition associated with the one component analysis result and the acquisition condition included in the analysis record.

11. The analysis device according to claim 10, wherein
the acquisition condition includes lens information, and
the identifying section calculates the image similarity degree such that the image similarity degree increases as a matching degree between lens information associated with the one component analysis result and the lens information included in the analysis record increases.

12. The analysis device according to claim 2, wherein
the component analysis section performs the component analysis of the analyte by extracting a characteristic of the analyte based on the spectrum.

13. The analysis device according to claim 12, further comprising
an analysis setting section that receives an analysis setting for performing the component analysis,
wherein the analysis setting section receives selection or an input of an essential item estimated to be included in the analyte, and
the component analysis section re-extracts a characteristic as the characteristic of the analyte by setting the essential item as an extraction target when the analysis setting section receives the selection or input of the essential item.

14. The analysis device according to claim 13, wherein
the analysis setting section receives selection or an input of an excluded item estimated not to be included in the analyte, and
the component analysis section re-extracts a characteristic as the characteristic of the analyte by setting the excluded item to be excluded from extraction targets when the analysis setting section receives the selection or input of the excluded item.

15. The analysis device according to claim 13, wherein
the analysis setting section receives at least one of an intensity of the electromagnetic wave or a primary ray emitted from the emitter and an integration time of the spectrum acquired by the spectrum acquirer as the analysis setting.

16. The analysis device according to claim 12, wherein
the component analysis section extracts a constituent element constituting the analyte and a content of the constituent element as the characteristic of the analyte.

17. The analysis device according to claim 12, wherein
the component analysis section extracts a molecular structure constituting the analyte as the characteristic of the analyte.

18. The analysis device according to claim 13, wherein
the analysis history holding section holds, as the analysis record, the analysis setting and the component analysis result in association with each other, and
the identifying section calculates a similarity degree such that a similarity degree between the one component analysis result and the component analysis result included in each of the analysis records increases as a matching degree between an analysis setting corresponding to the one component analysis result and the analysis setting included in the analysis record increases.

19. The analysis device according to claim 2, wherein
the analysis history holding section holds the spectrum and the component analysis result in association with each other as the analysis record, and
the display controller causes the display to display a difference spectrum representing a difference between a spectrum associated with the one component analysis result and a spectrum included in the similar analysis record, and
displays a peak position of the spectrum associated with the one component analysis result to be distinguishable on the difference spectrum.

20. An analysis device that irradiates an analyte with an electromagnetic wave or an electron beam to generate a spectrum and performs component analysis of the analyte based on the spectrum, the analysis device comprising a processor in communication with a memory, the processor being configured to execute instructions stored in the memory that cause the processor to:
acquire analysis data obtained by irradiating the analyte with the electromagnetic wave or electron beam;
identify analysis data similar to the analysis data from an analysis history holding section in which a plurality of pieces of analysis data, obtained by irradiating the analyte with an electromagnetic wave or an electron beam in advance, are held as an analysis history; and
cause a display to display the identified analysis data.
